SEQUENCE LISTING (117 sequences)

SEQ ID NO: 1 - DNA, 279 bp, Artificial Sequence
  plasmid insert sequence corresponding to a fragment of the FOXA1 gene
gcatgctaatacgactcactataggcgctcgggtgactgcagctgctcagctcccctcccccgccccgcgccgcgcggccgcccgtcgcttcgcacagggctggatggttgtattgggcagggtggctccaggatgttaggaactgtgaagatggaagggcatgaaaccagcgactggaacagctactacgcagacacgcaggaggcctactcctccgtcccggtcagcaacatgaactcaggcctgggctccatgaactccatgaacacctatctaga

SEQ ID NO: 2 - DNA, 279 bp, Artificial Sequence
  plasmid insert sequence corresponding to a fragment of the KRT5 gene
gcatgctaatacgactcactataggcatcaccgttcctgggtaacagagccaccttctgcgtcctgctgagctctgttctctccagcacctcccaacccactagtgcctggttctcttgctccaccaggaacaagccaccatgtctcgccagtcaagtgtgtccttccggagcgggggcagtcgtagcttcagcaccgcctctgccatcaccccgtctgtctcccgcaccagcttcacctccgtgtcccggtccgggggtggcggtggtggtgtctaga

SEQ ID NO: 3 - DNA, 279 bp, Artificial Sequence
  plasmid insert sequence corresponding to a fragment of the BCL2 gene
gcatgctaatacgactcactatagaaaaaaagatttatttatttaagacagtcccatcaaaactcctgtctttggaaatccgaccactaattgccaagcaccgcttcgtgtggctccacctggatgttctgtgcctgtaaacatagattcgctttccatgttgttggccggatcaccatctgaagagcagacggatggaaaaaggacctgatcattggggaagctggctttctggctgctggaggctggggagaaggtgttcattcacttgcatctaga

SEQ ID NO: 4 - DNA, 279 bp, Artificial Sequence
  plasmid insert sequence corresponding to a fragment of the BIRC5 gene
gcatgctaatacgactcactataggctttcttattttgtttgaattgttaattcacagaatagcacaaactacaattaaaactaagcacaaagccattctaagtcattggggaaacggggtgaacttcaggtggatgaggagacagaatagagtgataggaagcgtctggcagatactccttttgccactgctgtgtgattagacaggcccagtgagccgcggggcacatgctggccgctcctccctcagaaaaaggcagtggcctaaatccttctaga

SEQ ID NO: 5 - DNA, 279 bp, Artificial Sequence
  plasmid insert sequence corresponding to a fragment of the GPR160 gene
gcatgctaatacgactcactatagattattgcctgaatttctctaaaacaaccaagctttcatttaagtgtcaaaaattattttatttctttacagtaattttaatttggatttcagtccttgcttatgttttgggagacccagccatctaccaaagcctgaaggcacagaatgcttattctcgtcactgtcctttctatgtcagcattcagagttactggctgtcatttttcatggtgatgattttatttgtagctttcataacctgttgggtctaga

SEQ ID NO: 6 - DNA, 279 bp, Artificial Sequence
  plasmid insert sequence corresponding to a fragment of the CEP55 gene
gcatgctaatacgactcactatagaagaatgcttatcaactcacagagaaggacaaagaaatacagcgactgagagaccaactgaaggccagatatagtactaccgcattgcttgaacagctggaagagacaacgagagaaggagaaaggagggagcaggtgttgaaagccttatctgaagagaaagacgtattgaaacaacagttgtctgctgcaacctcacgaattgctgaacttgaaagcaaaaccaatacactccgtttatcacagacttctaga

SEQ ID NO: 7 - DNA, 279 bp, Artificial Sequence
  plasmid insert sequence corresponding to a fragment of the TYMS gene
gcatgctaatacgactcactatagatgaattccctctgctgacaaccaaacgtgtgttctggaagggtgttttggaggagttgctgtggtttatcaagggatccacaaatgctaaagagctgtcttccaagggagtgaaaatctgggatgccaatggatcccgagactttttggacagcctgggattctccaccagagaagaaggggacttgggcccagtttatggcttccagtggaggcattttggggcagaatacagagatatggaatcagtctaga

SEQ ID NO: 8 - DNA, 279 bp, Artificial Sequence
  plasmid insert sequence corresponding to a fragment of the SLC39A6 gene
gcatgctaatacgactcactatagatgtggagattaagaagcagttgtccaagtatgaatctcaactttcaacaaatgaggagaaagtagatacagatgatcgaactgaaggctatttacgagcagactcacaagagccctcccactttgattctcagcagcctgcagtcttggaagaagaagaggtcatgatagctcatgctcatccacaggaagtctacaatgaatatgtacccagagggtgcaagaataaatgccattcacatttccacgtctaga

SEQ ID NO: 9 - DNA, 279 bp, Artificial Sequence
  plasmid insert sequence corresponding to a fragment of the SFRP1 gene
gcatgctaatacgactcactatagattctcccgggggcagggtggggagggagcctcgggtggggtgggagcgggggggacagtgccccgggaacccggtgggtcacacacacgcactgcgcctgtcagtagtggacattgtaatccagtcggcttgttcttgcagcattcccgctcccttccctccatagccacgctccaaaccccagggtagccatggccgggtaaagcaagggccatttagattaggaaggtttttaagatccgcaatgttctaga

SEQ ID NO: 10 - DNA, 279 bp, Artificial Sequence
  plasmid insert sequence corresponding to a fragment of the MLPH gene
gcatgctaatacgactcactataggtttcagacattgaatccaggattgcagccctgagggccgcagggctcacggtgaagccctcgggaaagccccggaggaagtcaaacctcccgatatttctccctcgagtggctgggaaacttggcaagagaccagaggacccaaatgcagacccttcaagtgaggccaaggcaatggctgtgccctatcttctgagaagaaagttcagtaattccctgaaaagtcaaggtaaagatgatgattctttttctaga

SEQ ID NO: 11 - DNA, 279 bp, Artificial Sequence
  plasmid insert sequence corresponding to a fragment of the CENPF gene
gcatgctaatacgactcactatagaagaacaaccatggcaactcggaccagcccccgcctggctgcacagaagttagcgctatccccactgagtctcggcaaagaaaatcttgcagagtcctccaaaccaacagctggtggcagcagatcacaaaaggtcaaagttgctcagcggagcccagtagattcaggcaccatcctccgagaacccaccacgaaatccgtcccagtcaataatcttcctgagagaagtccgactgacagccccagagatctaga

SEQ ID NO: 12 - DNA, 279 bp, Artificial Sequence
  plasmid insert sequence corresponding to a fragment of the KRT14 gene
gcatgctaatacgactcactataggagcaggagatcgccacctaccgccgcctgctggagggcgaggacgcccacctctcctcctcccagttctcctctggatcgcagtcatccagagatgtgacctcctccagccgccaaatccgcaccaaggtcatggatgtgcacgatggcaaggtggtgtccacccacgagcaggtccttcgcaccaagaactgaggctgcccagccccgctcaggcctaggaggccccccgtgtggacacagatcccatctaga

SEQ ID NO: 13 - DNA, 279 bp, Artificial Sequence
  plasmid insert sequence corresponding to a fragment of the RRM2 gene
gcatgctaatacgactcactatagaaaacccccgccgctttgtcatcttccccatcgagtaccatgatatctggcagatgtataagaaggcagaggcttccttttggaccgccgaggaggttgacctctccaaggacattcagcactgggaatccctgaaacccgaggagagatattttatatcccatgttctggctttctttgcagcaagcgatggcatagtaaatgaaaacttggtggagcgatttagccaagaagttcagattacagaagtctaga

SEQ ID NO: 14 - DNA, 279 bp, Artificial Sequence
  plasmid insert sequence corresponding to a fragment of the FOXC1 gene
gcatgctaatacgactcactataggccgcctcacctcgtggtacctgaaccaggcgggcggagacctgggccacttggcaagcgcggcggcggcggcggcggccgcaggctacccgggccagcagcagaacttccactcggtgcgggagatgttcgagtcacagaggatcggcttgaacaactctccagtgaacgggaatagtagctgtcaaatggccttcccttccagccagtctctgtaccgcacgtccggagctttcgtctacgactgtatctaga

SEQ ID NO: 15 - DNA, 279 bp, Artificial Sequence
  plasmid insert sequence corresponding to a fragment of the CDC20 gene
gcatgctaatacgactcactatagggcaccagcagtgctgaggtgcagctatgggatgtgcagcagcagaaacggcttcgaaatatgaccagtcactctgcccgagtgggctccctaagctggaacagctatatcctgtccagtggttcacgttctggccacatccaccaccatgatgttcgggtagcagaacaccatgtggccacactgagtggccacagccaggaagtgtgtgggctgcgctgggccccagatggacgacatttggccagttctaga

SEQ ID NO: 16 - DNA, 279 bp, Artificial Sequence
  plasmid insert sequence corresponding to a fragment of the PGR gene
gcatgctaatacgactcactataggccggattcagaagccagccagagcccacaatacagcttcgagtcattacctcagaagatttgtttaatctgtggggatgaagcatcaggctgtcattatggtgtccttacctgtgggagctgtaaggtcttctttaagagggcaatggaagggcagcacaactacttatgtgctggaagaaatgactgcatcgttgataaaatccgcagaaaaaactgcccagcatgtcgccttagaaagtgctgtcatctaga

SEQ ID NO: 17 - DNA, 279 bp, Artificial Sequence
  plasmid insert sequence corresponding to a fragment of the GRB7 gene
gcatgctaatacgactcactataggcagctttcctgagatccagggctttctgcagctgcggggttcaggacggaagctttggaaacgctttttctgcttcttgcgccgatctggcctctattactccaccaagggcacctctaaggatccgaggcacctgcagtacgtggcagatgtgaacgagtccaacgtgtacgtggtgacgcagggccgcaagctctacgggatgcccactgacttcggtttctgtgtcaagcccaacaagcttcgaatctaga

SEQ ID NO: 18 - DNA, 279 bp, Artificial Sequence
  plasmid insert sequence corresponding to a fragment of the ANLN gene
gcatgctaatacgactcactatagaaccaccgtttccatcgtctcgtagtccgacgcctggggcgatggatccgtttacggagaaactgctggagcgaacccgtgccaggcgagagaatcttcagagaaaaatggctgagaggcccacagcagctccaaggtctatgactcatgctaagcgagctagacagccactttcagaagcaagtaaccagcagcccctctctggtggtgaagagaaatcttgtacaaaaccatcgccatcaaaaaaactctaga

SEQ ID NO: 19 - DNA, 279 bp, Artificial Sequence
  plasmid insert sequence corresponding to a fragment of the EGFR gene
gcatgctaatacgactcactataggctcccagtacctgctcaactggtgtgtgcagatcgcaaagggcatgaactacttggaggaccgtcgcttggtgcaccgcgacctggcagccaggaacgtactggtgaaaacaccgcagcatgtcaagatcacagattttgggctggccaaactgctgggtgcggaagagaaagaataccatgcagaaggaggcaaagtgcctatcaagtggatggcattggaatcaattttacacagaatctataccctctaga

SEQ ID NO: 20 - DNA, 279 bp, Artificial Sequence
  plasmid insert sequence corresponding to a fragment of the MKI67 gene
gcatgctaatacgactcactataggttataagccctccagctcctagtcctaggaaaactccagttgccagtgatcaacgccgtaggtcctgcaaaacagcccctgcttccagcagcaaatctcagacagaggttcctaagagaggaggagaaagagtggcaacctgccttcaaaagagagtgtctatcagccgaagtcaacatgatattttacagatgatatgttccaaaagaagaagtggtgcttcggaagcaaatctgattgttgcaaaatctaga

SEQ ID NO: 21 - DNA, 279 bp, Artificial Sequence
  plasmid insert sequence corresponding to a fragment of the BAG1 gene
gcatgctaatacgactcactatagaggaggtgaccagggaggaaatggcggcagctgggctcaccgtgactgtcacccacagcaatgagaagcacgaccttcatgttacctcccagcagggcagcagtgaaccagttgtccaagacctggcccaggttgttgaagaggtcataggggttccacagtcttttcagaaactcatatttaagggaaaatctctgaaggaaatggaaacaccgttgtcagcacttggaatacaagatggttgccgggtctaga

SEQ ID NO: 22 - DNA, 279 bp, Artificial Sequence
  plasmid insert sequence corresponding to a fragment of the UBE2T gene
gcatgctaatacgactcactataggtaccccgttggtccgcgcgttgctgcgttgtgaggggtgtcagctcagtgcatcccaggcagctcttagtgtggagcagtgaactgtgtgtggttccttctacttggggatcatgcagagagcttcacgtctgaagagagagctgcacatgttagccacagagccacccccaggcatcacatgttggcaagataaagaccaaatggatgacctgcgagctcaaatattaggtggagccaacacacctttctaga

SEQ ID NO: 23 - DNA, 279 bp, Artificial Sequence
  plasmid insert sequence corresponding to a fragment of the MYBL2 gene
gcatgctaatacgactcactataggcacaaccacctcaaccctgaggtgaagaagtcttgctggaccgaggaggaggaccgcatcatctgcgaggcccacaaggtgctgggcaaccgctgggccgagatcgccaagatgttgccagggaggacagacaatgctgtgaagaatcactggaactctaccatcaaaaggaaggtggacacaggaggcttcttgagcgagtccaaagactgcaagcccccagtgtacttgctgctggagctcgaggatctaga

SEQ ID NO: 24 - DNA, 279 bp, Artificial Sequence
  plasmid insert sequence corresponding to a fragment of the MELK gene
gcatgctaatacgactcactatagatttgccccggatcaaaacggagattgaggccttgaagaacctgagacatcagcatatatgtcaactctaccatgtgctagagacagccaacaaaatattcatggttcttgagtactgccctggaggagagctgtttgactatataatttcccaggatcgcctgtcagaagaggagacccgggttgtcttccgtcagatagtatctgctgttgcttatgtgcacagccagggctatgctcacagggacctctaga

SEQ ID NO: 25 - DNA, 279 bp, Artificial Sequence
  plasmid insert sequence corresponding to a fragment of the MYC gene
gcatgctaatacgactcactataggtcaagttggacagtgtcagagtcctgagacagatcagcaacaaccgaaaatgcaccagccccaggtcctcggacaccgaggagaatgtcaagaggcgaacacacaacgtcttggagcgccagaggaggaacgagctaaaacggagcttttttgccctgcgtgaccagatcccggagttggaaaacaatgaaaaggcccccaaggtagttatccttaaaaaagccacagcatacatcctgtccgtccaatctaga

SEQ ID NO: 26 - DNA, 279 bp, Artificial Sequence
  plasmid insert sequence corresponding to a fragment of the CDC6 gene
gcatgctaatacgactcactatagattccttccctcttcagcagaagatcttggtttgctctttgatgctcttgatcaggcagttgaaaatcaaagaggtcactctggggaagttatatgaagcctacagtaaagtctgtcgcaaacagcaggtggcggctgtggaccagtcagagtgtttgtcactttcagggctcttggaagccaggggcattttaggattaaagagaaacaaggaaacccgtttgacaaaggtgtttttcaagattgaagtctaga

SEQ ID NO: 27 - DNA, 279 bp, Artificial Sequence
  plasmid insert sequence corresponding to a fragment of the MIA gene
gcatgctaatacgactcactataggagtgcagccaccctatctccatggctgtggcccttcaggactacatggcccccgactgccgattcctgaccattcaccggggccaagtggtgtatgtcttctccaagctgaagggccgtgggcggctcttctggggaggcagcgttcagggagattactatggagatctggctgctcgcctgggctatttccccagtagcattgtccgagaggaccagaccctgaaacctggcaaagtcgatgtgaagtctaga

SEQ ID NO: 28 - DNA, 279 bp, Artificial Sequence
  plasmid insert sequence corresponding to a fragment of the PHGDH gene
gcatgctaatacgactcactatagaacacccccaatgggaacagcctcagtgccgcagaactcacttgtggaatgatcatgtgcctggccaggcagattccccaggcgacggcttcgatgaaggacggcaaatgggagcggaagaagttcatgggaacagagctgaatggaaagaccctgggaattcttggcctgggcaggattgggagagaggtagctacccggatgcagtcctttgggatgaagactatagggtatgaccccatcatttcctctaga

SEQ ID NO: 29 - DNA, 279 bp, Artificial Sequence
  plasmid insert sequence corresponding to a fragment of the BLVRA gene
gcatgctaatacgactcactataggaactgtgggagctggctgagcagaaaggaaaagtcttgcacgaggagcatgttgaactcttgatggaggaattcgctttcctgaaaaaagaagtggtggggaaagacctgctgaaagggtcgctcctcttcacagctggcccgttggaagaagagcggtttggcttccctgcattcagcggcatctctcgcctgacctggctggtctccctctttggggagctttctcttgtgtctgccactttggaatctaga

SEQ ID NO: 30 - DNA, 279 bp, Artificial Sequence
  plasmid insert sequence corresponding to a fragment of the MDM2 gene
gcatgctaatacgactcactataggcgtcgtgcttccgcgcgccccgtgaaggaaactggggagtcttgagggacccccgactccaagcgcgaaaaccccggatggtgaggagcaggcaaatgtgcaataccaacatgtctgtacctactgatggtgctgtaaccacctcacagattccagcttcggaacaagagaccctggttagaccaaagccattgcttttgaagttattaaagtctgttggtgcacaaaaagacacttatactatgaaatctaga

SEQ ID NO: 31 - DNA, 279 bp, Artificial Sequence
  plasmid insert sequence corresponding to a fragment of the KIF2C gene
gcatgctaatacgactcactataggacttaacaaagtatctggagaaccaagcattctgctttgactttgcatttgatgaaacagcttcgaatgaagttgtctacaggttcacagcaaggccactggtacagacaatctttgaaggtggaaaagcaacttgttttgcatatggccagacaggaagtggcaagacacatactatgggcggagacctctctgggaaagcccagaatgcatccaaagggatctatgccatggcctcccgggacgtctctaga

SEQ ID NO: 32 - DNA, 279 bp, Artificial Sequence
  plasmid insert sequence corresponding to a fragment of the ESR1 gene
gcatgctaatacgactcactatagatgattggtctcgtctggcgctccatggagcacccagggaagctactgtttgctcctaacttgctcttggacaggaaccagggaaaatgtgtagagggcatggtggagatcttcgacatgctgctggctacatcatctcggttccgcatgatgaatctgcagggagaggagtttgtgtgcctcaaatctattattttgcttaattctggagtgtacacatttctgtccagcaccctgaagtctctggaatctaga

SEQ ID NO: 33 - DNA, 279 bp, Artificial Sequence
  plasmid insert sequence corresponding to a fragment of the KNTC2 gene
gcatgctaatacgactcactatagaaggccccgctgtcctgtctagcagatacttgcacggtttacagaaattcggtccctgggtcgtgtcaggaaactggaaaaaaggtcataagcatgaagcgcagttcagtttccagcggtggtgctggccgcctctccatgcaggagttaagatcccaggatgtaaataaacaaggcctctatacccctcaaaccaaagagaaaccaacctttggaaagttgagtataaacaaaccgacatctgaaagatctaga

SEQ ID NO: 34 - DNA, 279 bp, Artificial Sequence
  plasmid insert sequence corresponding to a fragment of the EXO1 gene
gcatgctaatacgactcactatagggaaagcaacttcttcgtgaggggaaagtctcggaagctcgagagtgtttcacccggtctatcaatatcacacatgccatggcccacaaagtaattaaagctgcccggtctcagggggtagattgcctcgtggctccctatgaagctgatgcgcagttggcctatcttaacaaagcgggaattgtgcaagccataattacagaggactcggatctcctagcttttggctgtaaaaaggtaattttaaagtctaga

SEQ ID NO: 35 - DNA, 279 bp, Artificial Sequence
  plasmid insert sequence corresponding to a fragment of the CCNB1 gene
gcatgctaatacgactcactatagatgtggatgcagaagatggagctgatccaaacctttgtagtgaatatgtgaaagatatttatgcttatctgagacaacttgaggaagagcaagcagtcagaccaaaatacctactgggtcgggaagtcactggaaacatgagagccatcctaattgactggctagtacaggttcaaatgaaattcaggttgttgcaggagaccatgtacatgactgtctccattattgatcggttcatgcagaataatttctaga

SEQ ID NO: 36 - DNA, 279 bp, Artificial Sequence
  plasmid insert sequence corresponding to a fragment of the CDH3 gene
gcatgctaatacgactcactatagatcagctaccgcatcctgagagacccagcagggtggctagccatggacccagacagtgggcaggtcacagctgtgggcaccctcgaccgtgaggatgagcagtttgtgaggaacaacatctatgaagtcatggtcttggccatggacaatggaagccctcccaccactggcacgggaacccttctgctaacactgattgatgtcaatgaccatggcccagtccctgagccccgtcagatcaccatctgctctaga

SEQ ID NO: 37 - DNA, 279 bp, Artificial Sequence
  plasmid insert sequence corresponding to a fragment of the CCNE1 gene
gcatgctaatacgactcactataggtatacttgctgcttcggccttgtatcatttctcgtcatctgaattgatgcaaaaggtttcagggtatcagtggtgcgacatagagaactgtgtcaagtggatggttccatttgccatggttataagggagacggggagctcaaaactgaagcacttcaggggcgtcgctgatgaagatgcacacaacatacagacccacagagacagcttggatttgctggacaaagcccgagcaaagaaagccatgttctaga

SEQ ID NO: 38 - DNA, 279 bp, Artificial Sequence
  plasmid insert sequence corresponding to a fragment of the KRT17 gene
gcatgctaatacgactcactatagaatacaaaatcctgctggatgtgaagacgcggctggagcaggagattgccacctaccgccgcctgctggagggagaggatgcccacctgactcagtacaagaaagaaccggtgaccacccgtcaggtgcgtaccattgtggaagaggtccaggatggcaaggtcatctcctcccgcgagcaggtccaccagaccacccgctgaggactcagctaccccggccggccacccaggaggcagggagcagccgtctaga

SEQ ID NO: 39 - DNA, 279 bp, Artificial Sequence
  plasmid insert sequence corresponding to a fragment of the CDCA1 gene
gcatgctaatacgactcactatagagaggacggaggaaggaagcctgcagacagacgccttctccatcccaaggcgcgggcaggtgccgggacgctgggcctggcggtgttttcgtcgtgctcagcggtgggaggaggcggaagaaaccagagcctgggagattaacaggaaacttccaagatggaaactttgtctttccccagatataatgtagctgagattgtgattcatattcgcaataagatcttaacaggagctgatggtaaaaaccttctaga

SEQ ID NO: 40 - DNA, 279 bp, Artificial Sequence
  plasmid insert sequence corresponding to a fragment of the CXXC5 gene
gcatgctaatacgactcactatagaagccttccgctgctctggagaaggtgatgcttccgacgggagccgccttccggtggtttcagtgacggcggcggaacccaaagctgccctctccgtgcaatgtcactgctcgtgtggtctccagcaagggattcgggcgaagacaaacggatgcacccgtctttagaaccaaaaatattctctcacagatttcattcctgtttttatatatatattttttgttgtcgttttaacatctccacgtcccttctaga

SEQ ID NO: 41 - DNA, 279 bp, Artificial Sequence
  plasmid insert sequence corresponding to a fragment of the ORC6L gene
gcatgctaatacgactcactatagattctaaagctgaaagtggataaaaacaaaatggtagccacatccggtgtaaaaaaagctatatttgatcgactgtgtaaacaactagagaagattggacagcaggtcgacagagaacctggagatgtagctactccaccacggaagagaaagaagatagtggttgaagccccagcaaaggaaatggagaaggtagaggagatgccacataaaccacagaaagatgaagatctgacacaggattatgaatctaga

SEQ ID NO: 42 - DNA, 279 bp, Artificial Sequence
  plasmid insert sequence corresponding to a fragment of the ACTR3B gene
gcatgctaatacgactcactatagatatagtcaaggaatttgccaagtatgatgtggatccccggaagtggatcaaacagtacacgggtatcaatgcgatcaaccagaagaagtttgttatagacgttggttacgaaagattcctgggacctgaaatattctttcacccggagtttgccaacccagactttatggagtccatctcagatgttgttgatgaagtaatacagaactgccccatcgatgtgcggcgcccgctgtataagcccgagttctaga

SEQ ID NO: 43 - DNA, 279 bp, Artificial Sequence
  plasmid insert sequence corresponding to a fragment of the UBE2C gene
gcatgctaatacgactcactatagaagttcctcacgccctgctatcaccccaacgtggacacccagggtaacatatgcctggacatcctgaaggaaaagtggtctgccctgtatgatgtcaggaccattctgctctccatccagagccttctaggagaacccaacattgatagtcccttgaacacacatgctgccgagctctggaaaaaccccacagcttttaagaagtacctgcaagaaacctactcaaagcaggtcaccagccaggagccctctaga

SEQ ID NO: 44 - DNA, 279 bp, Artificial Sequence
  plasmid insert sequence corresponding to a fragment of the NAT1 gene
gcatgctaatacgactcactatagagcacttcctcatagaccttggatgtgggaggattgcattcagtctagttcctggttgccggctgaaataacctgaattcaagccaggaagaagcagcaatctgtcttctggattaaaactgaagatcaacctactttcaacttactaagaaaggggatcatggacattgaagcatatcttgaaagaattggctataagaagtctaggaacaaattggacttggaaacattaactgacattcttcaacatctaga

SEQ ID NO: 45 - DNA, 279 bp, Artificial Sequence
  plasmid insert sequence corresponding to a fragment of the PTTG1 gene
gcatgctaatacgactcactataggggtctggaccttcaatcaaagccttagatgggagatctcaagtttcaacaccacgttttggcaaaacgttcgatgccccaccagccttacctaaagctactagaaaggctttgggaactgtcaacagagctacagaaaagtctgtaaagaccaagggacccctcaaacaaaaacagccaagcttttctgccaaaaagatgactgagaagactgttaaagcaaaaagctctgttcctgcctcagatgattctaga

SEQ ID NO: 46 - DNA, 279 bp, Artificial Sequence
  plasmid insert sequence corresponding to a fragment of the MMP11 gene
gcatgctaatacgactcactataggatgaccagggcacagacctgctgcaggtggcagcccatgaatttggccacgtgctggggctgcagcacacaacagcagccaaggccctgatgtccgccttctacacctttcgctacccactgagtctcagcccagatgactgcaggggcgttcaacacctatatggccagccctggcccactgtcacctccaggaccccagccctgggcccccaggctgggatagacaccaatgagattgcaccgctgtctaga

SEQ ID NO: 47 - DNA, 279 bp, Artificial Sequence
  plasmid insert sequence corresponding to a fragment of the FGFR4 gene
gcatgctaatacgactcactataggctcccggccaacaccacagccgtggtgggcagcgacgtggagctgctgtgcaaggtgtacagcgatgcccagccccacatccagtggctgaagcacatcgtcatcaacggcagcagcttcggagccgacggtttcccctatgtgcaagtcctaaagactgcagacatcaatagctcagaggtggaggtcctgtacctgcggaacgtgtcagccgaggacgcaggcgagtacacctgcctcgcaggcaatctaga

SEQ ID NO: 48 - DNA, 279 bp, Artificial Sequence
  plasmid insert sequence corresponding to a fragment of the ERBB2 gene
gcatgctaatacgactcactataggtggagccgctgacacctagcggagcgatgcccaaccaggcgcagatgcggatcctgaaagagacggagctgaggaaggtgaaggtgcttggatctggcgcttttggcacagtctacaagggcatctggatccctgatggggagaatgtgaaaattccagtggccatcaaagtgttgagggaaaacacatcccccaaagccaacaaagaaatcttagacgaagcatacgtgatggctggtgtgggctcctctaga

SEQ ID NO: 49 - DNA, 279 bp, Artificial Sequence
  plasmid insert sequence corresponding to a fragment of the MAPT gene
gcatgctaatacgactcactatagagaggacacaaaagaggctgaccttccagagccctctgaaaagcagcctgctgctgctccgcgggggaagcccgtcagccgggtccctcaactcaaagctcgcatggtcagtaaaagcaaagacgggactggaagcgatgacaaaaaagccaagacatccacacgttcctctgctaaaaccttgaaaaataggccttgccttagccccaaacaccccactcctggtagctcagaccctctgatccaacctctaga

SEQ ID NO: 50 - DNA, 279 bp, Artificial Sequence
  plasmid insert sequence corresponding to a fragment of the TMEM45B gene
gcatgctaatacgactcactataggaacacccgaatgggaccagaaggatgatgccaacctcatgttcatcaccatgtgcttctgctggcactacctggctgccctcagcattgtggccgtcaactattctcttgtttactgccttttgactcggatgaagagacacggaaggggagaaatcattggaattcagaagctgaattcagatgacacttaccagaccgccctcttgagtggctcagatgaggaatgagccgagatgcggagggcgctctaga

SEQ ID NO: 51 - DNA, 279 bp, Artificial Sequence
  plasmid insert sequence corresponding to a fragment of the TFRC gene
gcatgctaatacgactcactatagaactttcattctttggacatgctcatctggggacaggtgacccttacacacctggattcccttccttcaatcacactcagtttccaccatctcggtcatcaggattgcctaatatacctgtccagacaatctccagagctgctgcagaaaagctgtttgggaatatggaaggagactgtccctctgactggaaaacagactctacatgtaggatggtaacctcagaaagcaagaatgtgaagctcactgtctaga

SEQ ID NO: 52 - DNA, 279 bp, Artificial Sequence
  plasmid insert sequence corresponding to a fragment of the GUSB gene
gcatgctaatacgactcactataggcgctgccgcagttcttcaacaacgtttctctgcatcaccacatgcaggtgatggaagaagtggtgcgtagggacaagaaccaccccgcggtcgtgatgtggtctgtggccaacgagcctgcgtcccacctagaatctgctggctactacttgaagatggtgatcgctcacaccaaatccttggacccctcccggcctgtgacctttgtgagcaactctaactatgcagcagacaagggggctccgtattctaga

SEQ ID NO: 53 - DNA, 279 bp, Artificial Sequence
  plasmid insert sequence corresponding to a fragment of the MRPL19 gene
gcatgctaatacgactcactatagaaaagatatgttagaaaggagaaaagtactccacattccagagttctatgttggaagtattcttcgtgttactacagctgacccatatgccagtggaaaaatcagccagtttctggggatttgcattcagagatcaggaagaggacttggagctactttcatccttaggaatgttatcgaaggacaaggtgtcgagatttgctttgaactttataatcctcgggtccaggagattcaggtggtcaaatttctaga

SEQ ID NO: 54 - DNA, 279 bp, Artificial Sequence
  plasmid insert sequence corresponding to a fragment of the SF3A1 gene
gcatgctaatacgactcactatagaacacatgcgcattggacttcttgaccctcgctggctggagcagcgggatcgctccatccgtgagaagcagagcgatgatgaggtgtacgcaccaggtctggatattgagagcagcttgaagcagttggctgagcggcgtactgacatcttcggtgtagaggaaacagccattggtaagaagatcggtgaggaggagatccagaagccagaggaaaaggtgacctgggatggccactcaggcagcatggtctaga

SEQ ID NO: 55 - DNA, 279 bp, Artificial Sequence
  plasmid insert sequence corresponding to a fragment of the PSMC4 gene
gcatgctaatacgactcactatagagcaaaagaacctgaaaaaggaatttctccatgcccaggaggaggtgaagcgaatccaaagcatcccgctggtcatcggacaatttctggaggctgtggatcagaatacagccatcgtgggctctaccacaggctccaactattatgtgcgcatcctgagcaccatcgatcgggagctgctcaagcccaacgcctcagtggccctccacaagcacagcaatgcactggtggacgtgctgccccccgaagtctaga

SEQ ID NO: 56 - DNA, 279 bp, Artificial Sequence
  plasmid insert sequence corresponding to a fragment of the RPLP0 gene
gcatgctaatacgactcactatagatgcccagggaagacagggcgacctggaagtccaactacttccttaagatcatccaactattggatgattatccgaaatgtttcattgtgggagcagacaatgtgggctccaagcagatgcagcagatccgcatgtcccttcgcgggaaggctgtggtgctgatgggcaagaacaccatgatgcgcaaggccatccgagggcacctggaaaacaacccagctctggagaaactgctgcctcatatccggtctaga

SEQ ID NO: 57 - DNA, 279 bp, Artificial Sequence
  plasmid insert sequence corresponding to a fragment of the PUM1 gene
gcatgctaatacgactcactataggtaaaaagttttgggaaacagatgaatccagcaaagatggaccaaaaggaatattcctgggtgatcaatggcgagacagtgcctggggaacatcagatcattcagtttcccagccaatcatggtgcagagaagacctggtcagagtttccatgtgaacagtgaggtcaattctgtactgtccccacgatcggagagtgggggactaggcgttagcatggtggagtatgtgttgagctcatccccgggcgtctaga

SEQ ID NO: 58 - DNA, 279 bp, Artificial Sequence
  plasmid insert sequence corresponding to a fragment of the ACTB gene
gcatgctaatacgactcactataggtccacacaggggaggtgatagcattgctttcgtgtaaattatgtaatgcaaaatttttttaatcttcgccttaatacttttttattttgttttattttgaatgatgagccttcgtgcccccccttccccctttttgtcccccaacttgagatgtatgaaggcttttggtctccctgggagtgggtggaggcagccagggcttacctgtacactgacttgagaccagttgaataaaagtgcacaccttatctaga

SEQ ID NO: 59 - DNA, 24 bp, Artificial Sequence
  chemically synthesized primer sequence named 5′ T7
gcatgctaatacgactcactatag

SEQ ID NO: 60 - DNA, 22 bp, Artificial Sequence
  chemically synthesized primer sequence named 3′ FOXA1ref
taggtgttcatggagttcatgg

SEQ ID NO: 61 - DNA, 18 bp, Artificial Sequence
  chemically synthesized primer sequence named 3′ KRT5ref
caccaccaccgccacccc

SEQ ID NO: 62 - DNA, 23 bp, Artificial Sequence
  chemically synthesized primer sequence named 3′ BCL2ref
tgcaagtgaatgaacaccttctc

SEQ ID NO: 63 - DNA, 21 bp, Artificial Sequence
  chemically synthesized primer sequence named 3′ BIRC5ref
aggatttaggccactgccttt

SEQ ID NO: 64 - DNA, 22 bp, Artificial Sequence
  chemically synthesized primer sequence named 3′ GPR160ref
cccaacaggttatgaaagctac

SEQ ID NO: 65 - DNA, 25 bp, Artificial Sequence
  chemically synthesized primer sequence named 3′ CEP55ref
agtctgtgataaacggagtgtattg

SEQ ID NO: 66 - DNA, 26 bp, Artificial Sequence
  chemically synthesized primer sequence named 3′ TYMSref
ctgattccatatctctgtattctgcc

SEQ ID NO: 67 - DNA, 26 bp, Artificial Sequence
  chemically synthesized primer sequence named 3′ SLC39A6ref
cgtggaaatgtgaatggcatttattc

SEQ ID NO: 68 - DNA, 24 bp, Artificial Sequence
  chemically synthesized primer sequence named 3′ SFRP1ref
tctaaatggcccttgctttacccg

SEQ ID NO: 69 - DNA, 26 bp, Artificial Sequence
  chemically synthesized primer sequence named 3′ MLPHref
aaaagaatcatcatctttaccttgac

SEQ ID NO: 70 - DNA, 18 bp, Artificial Sequence
  chemically synthesized primer sequence named 3′ CENPFref
tctctggggctgtcagtc

SEQ ID NO: 71 - DNA, 18 bp, Artificial Sequence
  chemically synthesized primer sequence named 3′ KRT14ref
tgggatctgtgtccacac

SEQ ID NO: 72 - DNA, 24 bp, Artificial Sequence
  chemically synthesized primer sequence named 3′ RRM2ref
cttctgtaatctgaacttcttggc

SEQ ID NO: 73 - DNA, 21 bp, Artificial Sequence
  chemically synthesized primer sequence named 3′ FOXC1ref
tacagtcgtagacgaaagctc

SEQ ID NO: 74 - DNA, 21 bp, Artificial Sequence
  chemically synthesized primer sequence named 3′ CDC20ref
actggccaaatgtcgtccatc

SEQ ID NO: 75 - DNA, 20 bp, Artificial Sequence
  chemically synthesized primer sequence named 3′ PGRref
tgacagcactttctaaggcg

SEQ ID NO: 76 - DNA, 20 bp, Artificial Sequence
  chemically synthesized primer sequence named 3′ GRB7ref
ttcgaagcttgttgggcttg

SEQ ID NO: 77 - DNA, 22 bp, Artificial Sequence
  chemically synthesized primer sequence named 3′ ANLNref
gtttttttgatggcgatggttt

SEQ ID NO: 78 - DNA, 29 bp, Artificial Sequence
  chemically synthesized primer sequence named 3′ EGFRref
gggtatagattctgtgtaaaattgattcc

SEQ ID NO: 79 - DNA, 24 bp, Artificial Sequence
  chemically synthesized primer sequence named 3′ MKI67ref
ttttgcaacaatcagatttgcttc

SEQ ID NO: 80 - DNA, 24 bp, Artificial Sequence
  chemically synthesized primer sequence named 3′ BAG1ref
acccggcaaccatcttgtattcca

SEQ ID NO: 81 - DNA, 21 bp, Artificial Sequence
  chemically synthesized primer sequence named 3′ UBE2Tref
aaggtgtgttggctccaccta

SEQ ID NO: 82 - DNA, 26 bp, Artificial Sequence
  chemically synthesized primer sequence named 3′ MYBL2ref
tcctcgagctccagcagcaagtacac

SEQ ID NO: 83 - DNA, 18 bp, Artificial Sequence
  chemically synthesized primer sequence named 3′ MELKref
ggtccctgtgagcatagc

SEQ ID NO: 84 - DNA, 21 bp, Artificial Sequence
  chemically synthesized primer sequence named 3′ MYCref
ttggacggacaggatgtatgc

SEQ ID NO: 85 - DNA, 29 bp, Artificial Sequence
  chemically synthesized primer sequence named 3′ CDC6ref
cttcaatcttgaaaaacaccttaaacggg

SEQ ID NO: 86 - DNA, 20 bp, Artificial Sequence
  chemically synthesized primer sequence named 3′ MIAref
cttcacatcgactttgccag

SEQ ID NO: 87 - DNA, 24 bp, Artificial Sequence
  chemically synthesized primer sequence named 3′ PHGDHref
ggaaatgatggggtcataccctat

SEQ ID NO: 88 - DNA, 22 bp, Artificial Sequence
  chemically synthesized primer sequence named 3′ BLVRAref
ttccaaagtggcagacacaaga

SEQ ID NO: 89 - DNA, 27 bp, Artificial Sequence
  chemically synthesized primer sequence named 3′ MDM2ref
tttcatagtataagtgtctttttgtgc

SEQ ID NO: 90 - DNA, 18 bp, Artificial Sequence
  chemically synthesized primer sequence named 3′ KIF2Cref
gacgtcccgggaggccat

SEQ ID NO: 91 - DNA, 19 bp, Artificial Sequence
  chemically synthesized primer sequence named 3′ ESR1ref
ttccagagacttcagggtg

SEQ ID NO: 92 - DNA, 26 bp, Artificial Sequence
  chemically synthesized primer sequence named 3′ KNTC2ref
tctttcagatgtcggtttgtttatac

SEQ ID NO: 93 - DNA, 29 bp, Artificial Sequence
  chemically synthesized primer sequence named 3′ EXO1ref
ctttaaaattacctttttacagccaaaag

SEQ ID NO: 94 - DNA, 29 bp, Artificial Sequence
  chemically synthesized primer sequence named 3′ CCNB1ref
aattattctgcatgaaccgatcaataatg

SEQ ID NO: 95 - DNA, 19 bp, Artificial Sequence
  chemically synthesized primer sequence named 3′ CDH3ref
gcagatggtgatctgacgg

SEQ ID NO: 96 - DNA, 19 bp, Artificial Sequence
  chemically synthesized primer sequence named 3′ CCNE1ref
acatggctttctttgctcg

SEQ ID NO: 97 - DNA, 18 bp, Artificial Sequence
  chemically synthesized primer sequence named 3′ KRT17ref
cggctgctccctgcctcc

SEQ ID NO: 98 - DNA, 22 bp, Artificial Sequence
  chemically synthesized primer sequence named 3′ CDCA1ref
aggtttttaccatcagctcctg

SEQ ID NO: 99 - DNA, 22 bp, Artificial Sequence
  chemically synthesized primer sequence named 3′ CXXC5ref
agggacgtggagatgttaaaac

SEQ ID NO: 100 - DNA, 24 bp, Artificial Sequence
  chemically synthesized primer sequence named 3′ ORC6Lref
ttcataatcctgtgtcagatcttc

SEQ ID NO: 101 - DNA, 19 bp, Artificial Sequence
  chemically synthesized primer sequence named 3′ ACTR3Bref
actcgggcttatacagcgg

SEQ ID NO: 102 - DNA, 18 bp, Artificial Sequence
  chemically synthesized primer sequence named 3′ UBE2Cref
gggctcctggctggtgac

SEQ ID NO: 103 - DNA, 26 bp, Artificial Sequence
  chemically synthesized primer sequence named 3′ NAT1ref
tgttgaagaatgtcagttaatgtttc

SEQ ID NO: 104 - DNA, 21 bp, Artificial Sequence
  chemically synthesized primer sequence named 3′ PTTG1ref
atcatctgaggcaggaacaga

SEQ ID NO: 105 - DNA, 19 bp, Artificial Sequence
  chemically synthesized primer sequence named 3′ MMP11ref
cagcggtgcaatctcattg

SEQ ID NO: 106 - DNA, 18 bp, Artificial Sequence
  chemically synthesized primer sequence named 3′ FGFR4ref
ttgcctgcgaggcaggtg

SEQ ID NO: 107 - DNA, 19 bp, Artificial Sequence
  chemically synthesized primer sequence named 3′ ERBB2ref
ggagcccacaccagccatc

SEQ ID NO: 108 - DNA, 19 bp, Artificial Sequence
  chemically synthesized primer sequence named 3′ MAPTref
ggttggatcagagggtctg

SEQ ID NO: 109 - DNA, 18 bp, Artificial Sequence
  chemically synthesized primer sequence named 3′ TMEM45Bref
gcgccctccgcatctcgg

SEQ ID NO: 110 - DNA, 21 bp, Artificial Sequence
  chemically synthesized primer sequence named 3′ TFRCref
cagtgagcttcacattcttgc

SEQ ID NO: 111 - DNA, 18 bp, Artificial Sequence
  chemically synthesized primer sequence named 3′ GUSBref
atacggagcccccttgtc

SEQ ID NO: 112 - DNA, 21 bp, Artificial Sequence
  chemically synthesized primer sequence named 3′ MRPL19ref
aatttgaccacctgaatctcc

SEQ ID NO: 113 - DNA, 18 bp, Artificial Sequence
  chemically synthesized primer sequence named 3′ SF3A1ref
ccatgctgcctgagtggc

SEQ ID NO: 114 - DNA, 19 bp, Artificial Sequence
  chemically synthesized primer sequence named 3′ PSMC4ref
cttcggggggcagcacgtc

SEQ ID NO: 115 - DNA, 22 bp, Artificial Sequence
  chemically synthesized primer sequence named 3′ RPLP0ref
ccggatatgaggcagcagtttc

SEQ ID NO: 116 - DNA, 20 bp, Artificial Sequence
  chemically synthesized primer sequence named 3′ PUM1ref
cgcccggggatgagctcaac

SEQ ID NO: 117 - DNA, 25 bp, Artificial Sequence
  chemically synthesized primer sequence named 3′ ACTBref
taaggtgtgcacttttattcaactg

(19) United States
(12) Patent Application Publication
(10) Pub. No.: US 2013/0017971 A1
(43) Pub. Date: Jan. 17, 2013

(54) Multivariate Diagnostic Assays and Methods for Using Same

(71) Applicants: Gary K. Geiss, Seattle, WA (US); Sean M. Ferree, Seattle, WA (US); Philippa J. Webster, Seattle, WA (US); James J. Storhoff, Seattle, WA (US); Brett Wallden, Mill Creek, WA (US); Emily Payandeh, San Mateo, CA (US)

(72) Inventors: Gary K. Geiss, Seattle, WA (US); Sean M. Ferree, Seattle, WA (US); Philippa J. Webster, Seattle, WA (US); James J. Storhoff, Seattle, WA (US); Brett Wallden, Mill Creek, WA (US); Emily Payandeh, San Mateo, CA (US)

(73) Assignee: NanoString Technologies, Inc., Seattle, WA (US)

(21) Appl. No.: 13/530,848

(22) Filed: Jun. 22, 2012

Related U.S. Application Data
(60) Provisional application No. 61/501,170, filed on Jun. 24, 2011.

(51) Int. Cl. C40B 30/04; C40B 40/06

(52) U.S. Cl. 506/9; 506/16

(57) ABSTRACT

The application describes compositions and methods for detecting the relative expressions of a plurality of target nucleic acid molecules in one assay. The compositions comprise a plurality of probe molecules which specifically bind to one target nucleic acid molecule of a plurality of target nucleic acids in a sample, and a plurality of reference molecules that represent each of the plurality of target nucleic acid molecules, where the probe molecules specifically bind to the plurality of reference molecules, and each of the plurality of reference molecules is present in known amounts in the composition.

### CROSS-REFERENCE TO RELATED APPLICATIONS

This application claims priority to, and the benefit of, U.S. Ser. No. 61/501,170, filed Jun. 24, 2011, the contents of which are herein incorporated by reference in its entirety.

### FIELD OF THE INVENTION

This disclosure relates generally to the field of detection and identification of nucleic acid expression signatures.

### BACKGROUND OF THE INVENTION

The accurate identification of particular gene expression profiles is of considerable importance for translational research for biological pathway analysis, multiplexed biomarker assays and diagnostic assays. Of particular importance, there is a need in the art for reliable and distributable tools and techniques for translational research and diagnostics, which will provide highly reproducible measurement techniques across reagent lots, operators, instruments, and laboratories. The present invention solves these needs.

### SUMMARY OF THE INVENTION

The present invention provides a composition for the multiplexed detection of a plurality of target nucleic acid molecules from a biological sample including a plurality of probe molecules, where each probe molecule in the plurality specifically binds to one target nucleic acid molecule in the sample, The composition can further include a plurality of reference molecules that represent each of the plurality of target nucleic acid molecules, wherein the probe molecules specifically bind to the plurality of reference molecules, and wherein each of the plurality of reference molecules is present in known amounts. The probe molecules are capable of enzymatic or non-enzymatic direct detection of the target nucleic acid molecules. Preferably, the probe molecules are capable of non-enzymatic direct detection of the target nucleic acid molecules. Preferably, the detection of the target nucleic acid molecules occurs without target nucleic acid amplification.

The plurality of reference molecules that represent each of the plurality of nucleic acid molecules can include synthesized nucleic acids. The plurality of synthesized reference molecules that represent each of the plurality of nucleic acid molecules can include in vitro transcribed RNA or chemically synthesized nucleic acids. The reference molecules can be used to correct for variations in efficiency of an individual assay. The variations in efficiency can include lot-to-lot, site-to-site, and user-to-user variation. The reference molecules can be used to quantify normal expression and/or normalize expression between different assays. Each of the reference molecules includes a target-specific region that is representative of the target nucleic acid molecule; the target specific region can be the same nucleic acid sequence as the target nucleic acid molecule, or a sequence that is highly homologous to the target nucleic acid molecule such that binding to the reference is representative of binding to the target under the hybridization conditions employed.

The plurality of probe molecules can include about 8 to about 50 probe molecules, about 15 to about 50 probe molecules, about 25 to about 50 probe molecules, about 50 to about 100 probe molecules or more than 100 probe molecules. The probe molecules can be nucleic acid probes. Each nucleic acid probe can include: (i) a target-specific region that specifically binds to a target nucleic acid molecule; and (ii) a region including a plurality of label-attachment regions linked together, wherein each label attachment region is attached to a plurality of label monomers that create a unique code for each target-specific probe, the code having a detectable signal that distinguishes one nucleic acid probe which binds to a first target nucleic acid from another nucleic acid probe that binds to a different second target nucleic acid molecule. The plurality of label-attachment regions can include at least four, at least five, at least six, at least seven label attachment regions. The plurality of label monomers includes at least four, at least five, at least six, at least seven label monomers. The number of label monomers used can vary depending on the complexity of the plurality of target nucleic acid molecules. Each of the label monomers can be selected from the group consisting of a fluorochrome moiety, a fluorescent moiety, a dye moiety and a chemiluminescent moiety. The nucleic acid probe can further include an affinity tag.

The biological sample can be a tissue or cell sample. The biological sample can be a tumor sample. The tumor sample can be a breast tissue sample. The biological sample can be a formalin-fixed paraffin-embedded tissue sample.

The present invention also provides a kit including a composition for the multiplexed detection of a plurality of target nucleic acid molecules from a biological sample including a plurality of probe molecules, where each probe molecule in the plurality specifically binds to one target nucleic acid molecule in the sample, and instructions for the multiplexed detection of a plurality of target nucleic acid molecules. The composition included within the kit can further include a plurality of reference molecules that represent each of the plurality of target nucleic acid molecules, wherein the probe molecules specifically bind to the plurality of reference molecules, and wherein each of the plurality of reference molecules is present in known amounts. The probe molecules are capable of enzymatic or non-enzymatic direct detection of the target nucleic acid molecules. Preferably, the probe molecules are capable of non-enzymatic direct detection of the target nucleic acid molecules. The kit can further include an apparatus which includes a surface suitable for binding, and optionally detecting, the probe molecules included with the kit. Preferably, the probe molecules are hybridized to the target nucleic acids or the reference molecules when bound to the surface. The probe molecules may be bound to the surface by any means known in the art. The kit can further include a composition for the extraction of the target nucleic acids from a biological sample. The kit can further include a reagent selected from the group consisting of a hybridization reagent, a purification reagent, an immobilization reagent and an imaging reagent.

The present invention also provides methods of detecting the expression of a plurality of target nucleic acid molecules from a biological sample including: providing a biological sample; providing a plurality of probe molecules, wherein each probe molecule in the plurality specifically binds to one target nucleic acid molecule in the sample; contacting the biological sample and the plurality of probe molecules under conditions sufficient for hybridization of at least one probe molecule and one target nucleic acid molecule; and detecting a signal associated with each of the plurality of probe molecules bound to each corresponding target nucleic acid molecule. The detection can be enzymatic or non-enzymatic. Preferably, the detection is non-enzymatic. Preferably, the signal is detected without target nucleic acid amplification.

The method further includes providing a plurality of reference molecules that represent each of the plurality of target nucleic acid molecules, wherein each of the plurality of reference molecules is present in known amounts; detecting a signal associated with each of the plurality of probe molecules bound to each corresponding reference nucleic acid molecule; and normalizing the signal associated with each of the plurality of probe molecules bound to each corresponding target nucleic acid molecule with the corresponding signal associated with each of the plurality of probe molecules bound to each corresponding reference nucleic acid molecule, thereby quantifying the regular (normal) expression of the plurality of target nucleic acid molecules.

The plurality of reference molecules that represent each of the plurality of nucleic acid molecules can include synthesized nucleic acids. The plurality of synthesized reference molecules that represent each of the plurality of nucleic acid molecules can include in vitro transcribed RNA or chemically synthesized nucleic acids. The reference molecules can be used to correct for variations in efficiency of an individual assay. The variations in efficiency can include lot-to-lot, site-to-site, and user-to-user variation. The reference molecules can be used to quantify normal expression and/or normalize expression between different assays. Each of the reference molecules includes a target-specific region that is representative of the target nucleic acid molecule; the target specific region can be the same nucleic acid sequence as the target nucleic acid molecule, or a sequence that is highly homologous to the target nucleic acid molecule such that binding to the reference is representative of binding to the target under the hybridization conditions employed.

The plurality of probe molecules can include about 8 to about 50 probe molecules, about 15 to about 50 probe molecules, about 25 to about 50 probe molecules, about 50 to about 100 probe molecules or more than 100 probe molecules. The probe molecules can be nucleic acid probes. Each nucleic acid probe can include: (i) a target-specific region that specifically binds to a target nucleic acid molecule; and (ii) a region including a plurality of label-attachment regions linked together, wherein each label attachment region is attached to a plurality of label monomers that create a unique code for each target-specific probe, the code having a detectable signal that distinguishes one nucleic acid probe which binds to a first target nucleic acid from another nucleic acid probe that binds to a different second target nucleic acid molecule. The plurality of label-attachment regions can include at least four, at least five, at least six, at least seven label attachment regions. The plurality of label monomers includes at least four, at least five, at least six, at least seven label monomers. The number of label monomers used can vary depending on the complexity of the plurality of target nucleic acid molecules. Each of the label monomers can be selected from the group consisting of a fluorochrome moiety, a fluorescent moiety, a dye moiety and a chemiluminescent moiety. The nucleic acid probe can further include an affinity tag.

The biological sample can be a tissue or cell sample. The biological sample can be a tumor sample. The tumor sample can be a breast tissue sample. The biological sample can be a formalin-fixed paraffin-embedded tissue sample.

Unless otherwise defined, all technical and scientific terms used herein have the same meaning as commonly understood by one of ordinary skill in the art to which this invention belongs. In the specification, the singular forms also include the plural unless the context clearly dictates otherwise. Although methods and materials similar or equivalent to those described herein can be used in the practice or testing of the present invention, suitable methods and materials are described below. All publications, patent applications, patents and other references mentioned herein are incorporated by reference. The references cited herein are not admitted to be prior art to the claimed invention. In the case of conflict, the present specification, including definitions, will control. In addition, the materials, methods and examples are illustrative only and are not intended to be limiting.

Other features and advantages of the invention will be apparent from the following detailed description and claims.

### BRIEF DESCRIPTION OF THE DRAWINGS

FIG. 1 shows a schematic of a synthetic pool of nucleic acids used as a reference sample. In this example, the pool consists of 10 in vitro transcribed RNAs containing 10 different target sequences that correspond to the target sequences of 10 endogenous genes being interrogated in the test biological samples.

FIG. 2 is a schematic showing gene-specific probe pairs.

FIG. 3 is a schematic showing the removal of excess capture and Reporter Probes.

FIG. 4 is a schematic showing binding of the probe-target complexes to random locations on the surface of the nCounter® cartridge via a streptavidin-biotin linkage.

FIG. 5 is a schematic showing the alignment and immobilization of probe/target complexes.

FIG. 6 is a table showing how Reporter Probes on the surface of a cartridge are counted and tabulated for each target molecule.

FIG. 7 shows an agarose gel showing PCR amplicons.

FIG. 8 shows a denaturing gel containing in vitro transcribed RNA products visualized by UV light at 260 nm.

FIG. 9 is a schematic showing the use of a reference sample for data normalization in a multivariate gene assay.

### DETAILED DESCRIPTION OF THE INVENTION

The present invention provides a composition for the multiplexed detection of a plurality of target nucleic acid molecules from a biological sample including a plurality of probe molecules, where each probe molecule in the plurality specifically binds to one target nucleic acid molecule in the sample, The composition can further include a plurality of reference molecules that represent each of the plurality of target nucleic acid molecules, wherein the probe molecules specifically bind to the plurality of reference molecules, and wherein each of the plurality of reference molecules is present in known amounts. The probe molecules are capable of enzymatic or non-enzymatic direct detection of the target nucleic acid molecules. Preferably, the probe molecules are capable of non-enzymatic direct detection of the target nucleic acid molecules. Preferably, the detection of the target nucleic acid molecules occurs without target nucleic acid amplification.

The present invention also provides a kit including a composition for the multiplexed detection of a plurality of target nucleic acid molecules from a biological sample including a plurality of probe molecules, where each probe molecule in the plurality specifically binds to one target nucleic acid molecule in the sample, and instructions for the multiplexed detection of a plurality of target nucleic acid molecules. The composition included within the kit can further include a plurality of reference molecules that represent each of the plurality of target nucleic acid molecules, wherein the probe molecules specifically bind to the plurality of reference molecules, and wherein each of the plurality of reference molecules is present in known amounts. The probe molecules are capable of enzymatic or non-enzymatic direct detection of the target nucleic acid molecules. Preferably, the probe molecules are capable of non-enzymatic direct detection of the target nucleic acid molecules. The kit can further include an apparatus which includes a surface suitable for hybridizing, and optionally detecting, the probe molecules included with the kit. Preferably, the probe molecules are hybridized to the target nucleic acids or the reference molecules when bound to the surface. The probe molecules may be bound to the surface by any means known in the art. The kit can further include a composition for the extraction of the target nucleic acids from a biological sample. The kit can further include a reagent selected from the group consisting of a hybridization reagent, a purification reagent, an immobilization reagent and an imaging reagent.

The present invention also provides methods of detecting the expression of a plurality of target nucleic acid molecules from a biological sample including: providing a biological sample; providing a plurality of probe molecules, wherein each probe molecule in the plurality specifically binds to one target nucleic acid molecule in the sample; contacting the biological sample and the plurality of probe molecules under conditions sufficient for hybridization of at least one probe molecule and one target nucleic acid molecule; and detecting a signal associated with each of the plurality of probe molecules bound to each corresponding target nucleic acid molecule. The detection can be enzymatic or non-enzymatic. Preferably, the detection is non-enzymatic. Preferably, the signal is detected without target nucleic acid amplification.

The method further includes providing a plurality of reference molecules that represent each of the plurality of target nucleic acid molecules, wherein each of the plurality of reference molecules is present in known amounts; detecting a signal associated with each of the plurality of probe molecules bound to each corresponding reference nucleic acid molecule; and normalizing the signal associated with each of the plurality of probe molecules bound to each corresponding target nucleic acid molecule with the corresponding signal associated with each of the plurality of probe molecules bound to each corresponding reference nucleic acid molecule, thereby quantifying the regular (normal) expression of the plurality of target nucleic acid molecules. Thus the present invention provides methods of creating reference molecules that relies on creating each gene sequence of interest using molecular biology or other synthesis techniques and artificially mixing them. This approach provides surprisingly superior and precise control of the amount of each gene within the reference molecule, and it also enables replication of the reference molecules in various reagent lots.

The plurality of reference molecules that represent each of the plurality of nucleic acid molecules can include synthesized nucleic acids. The plurality of synthesized reference molecules that represent each of the plurality of nucleic acid molecules can include in vitro transcribed RNA or chemically synthesized nucleic acids. The reference molecules can be used to correct for variations in efficiency of an individual assay. The variations in efficiency can include lot-to-lot, site-to-site, and user-to-user variation. The reference molecules can be used to quantify normal expression and/or normalize expression between different assays. Each of the reference molecules includes a target-specific region that is representative of the target nucleic acid molecule; the target specific region can be the same nucleic acid sequence as the target nucleic acid molecule, or a sequence that is highly homologous to the target nucleic acid molecule such that binding to the reference is representative of binding to the target under the hybridization conditions employed.

The plurality of probe molecules can include about 8 to about 50 probe molecules, about 15 to about 50 probe molecules, about 25 to about 50 probe molecules, about 50 to about 100 probe molecules or more than 100 probe molecules. The probe molecules can be nucleic acid probes. Each nucleic acid probe can include: (i) a target-specific region that specifically binds to a target nucleic acid molecule; and (ii) a region including a plurality of label-attachment regions linked together, wherein each label attachment region is attached to a plurality of label monomers that create a unique code for each target-specific probe, the code having a detectable signal that distinguishes one nucleic acid probe which binds to a first target nucleic acid from another nucleic acid probe that binds to a different second target nucleic acid molecule. The plurality of label-attachment regions can include at least four, at least five, at least six, at least seven label attachment regions. The plurality of label monomers includes at least four, at least five, at least six, at least seven label monomers. The number of label monomers used can vary depending on the complexity of the plurality of target nucleic acid molecules. Each of the label monomers can be selected from the group consisting of a fluorochrome moiety, a fluorescent moiety, a dye moiety and a chemiluminescent moiety. The nucleic acid probe can further include an affinity tag.

The biological sample can be a tissue or cell sample. The biological sample can be a tumor sample. The tumor sample can be a breast tissue sample. The biological sample can be a formalin-fixed paraffin-embedded tissue sample.

This disclosure describes compositions and methods for measuring the amount of multiple nucleic acid molecules in one assay. The compositions and methods described herein can also be utilized in translational research for discovery of pathway analysis, multiplexed biomarker assays and diagnostic assays. The compositions and methods described herein can be used to determine a specific nucleic acid expression signature using multiplexed measurements of target nucleic acid molecules in conjunction with a reference sample comprised of a synthetic pool of reference molecules. These nucleic acid expression signatures can be used for various purposes, for example, to diagnose a disease state or for prognosis of disease in an individual patient.

The compositions and methods described herein use nucleic acid target measurements combined with measurements of a reference sample, which is comprised of a synthetic pool of reference molecules, was a normalization tool. Both the nucleic acid target and reference sample measurements are performed with probe nucleic acid molecules. Each diagnostic nucleic acid molecule specifically binds with a target nucleic acid molecule and includes a means for detecting the specific interaction between the diagnostic nucleic acid molecule and the target nucleic acid molecule. Several examples of using reference sample normalization for nucleic acid target molecules and methods for their detection using probe nucleic acid molecules are provided below.

The reference sample can be specifically designed to correspond with the same nucleic acid targets as the probe nucleic acid molecules. The reference sample contains nucleic acid molecules that include the same or similar sequences as the target nucleic acid molecules. These sequences are such that the probe nucleic acid molecules specifically bind to the nucleic acid sequences in the reference sample as they do to the target nucleic acid sequences.

When large cohorts of samples are assayed with an expression signature as a part of translational research studies using a single batch of reagents, the data can be analyzed using methods such as hierarchical clustering or principle component analysis. These statistical techniques will group samples with similar characteristics together so that their properties can be linked to clinical outcomes. A much more difficult task is robustly predicting clinical outcome on individual samples using a distributed diagnostic test. The added variability of different users running the assay on different instruments in different laboratories using changing lots of reagents over time can lead to incorrect classification. The synthetic nature of the pool of reference samples allows for precise control of the concentrations of reference nucleic acid molecules and ensures that all targets will be well within the linear range of the assay and will all have similar variances. The signal obtained from the synthetic pool reference sample can be used to correct for variations in assay efficiency that arise due to various sources, including reagent lot-to-lot, site-to-site, and user-to-user variation. The unique features of this diagnostic method permits a complex multivariate assay to be run on individual samples at various different sites across the country and the world and at different times with accurate and precise results. The pool of nucleic acids can be synthesized according to any method known in the art. These methods include in vitro transcription of RNA and chemical synthesis.

Nucleic acid molecules that can be detected using the compositions and methods described herein include RNA and DNA. RNA can include messenger RNA (mRNA), ribosomal RNA (rRNA), transfer RNA (tRNA), short interfering RNA (siRNA), micro RNA (miRNA), long non-coding RNA (lincRNA), viral RNA or any combination thereof. DNA can include genomic DNA or recombinant DNA. DNA can be single or double stranded. In certain specific embodiments, the nucleic acids molecules that can be detected using the compositions and methods described herein include a mixture of miRNA and mRNA.

Nucleic acid expression signatures can represent various biological activity states and disease states. Biological activity states include the expression signatures of biological samples, clinical samples and model systems. Nucleic acid expression signatures can be used with biomarker based assays to elucidate biological activity states. These biological activity states can be associated with understanding biological pathways including drug activity and drug mechanisms. Disease states include cancer, infectious diseases, chronic pathologies and neurological disorders. Cancers can include colon, brain, breast, ovarian, testicular, lung, or bone cancer. Cancers also include leukemia or lymphoma. Infectious diseases include acquired immune deficiency syndrome (AIDS), hepatitis, tuberculosis, cholera, malaria, influenza and human papilloma virus (HPV) infections. Chronic pathologies include cardiovascular disease, muscular dystrophy, multiple sclerosis (MS), osteoporosis, anemia, asthma, lupus, auto-immune disorders, obesity, diabetes and metabolic disorders. Neurological disorders include Alzheimer's disease, Parkinson's disease, depression, anxiety disorders, bipolar disorder, dementia and amyotrophic lateral sclerosis (ALS).

Sets of nucleic acids to be detected include ones described in Paik et al. N. Engl. J. Med., 351(27): 2817-26, and Paik et al. Journal of Clinical Oncology 24(23): 3726-3734 (August 2006) incorporated herein by reference in their entireties and described in greater detail in the examples, below. The sets of nucleic acids described therein may be detected in whole or in part. For example, Paik et al. described a 21 gene set. The expression level of all 21 genes may be detected according to the methods and compositions described herein. Also, the expression level of between 2 and 20 of the genes may be detected according to the methods and compositions described herein. In certain embodiments, the expression levels of 2, 3, 4, 5, 6, 7, 8, 9, 10, 11, 12, 13, 14, 15, 16, 17, 18, 19 or 20 of the genes are detected according to the methods and compositions described herein.

Sets of nucleic acids to be detected also include ones described in International Publication No. WO 09/158143 and U.S. Patent Publication No. 2011/0145176, incorporated herein by reference in its entirety. The sets of nucleic acids described therein may be detected in whole or in part. For example, WO 09/158143 and U.S. Patent Publication No. 2011/0145176 each described a 50 gene set with 8 housekeeping genes. The expression level of all 50 genes and/or all 8 housekeeping genes may be detected according to the methods and compositions described herein. Also, the expression level of between 2 and 50 of the genes may be detected according to the methods and compositions described herein. In certain embodiments, the expression levels of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 of the genes are detected according to the methods and compositions described herein. In certain embodiments, the expression levels of 2, 3, 4, 5, 6, 7 or 8 of the housekeeping genes are detected according to the methods and compositions described herein.

Sets of nucleic acids to be detected also include ones described in van't Veer et al. Nature 415: 530-536 (January 2002) incorporated herein by reference in their entirety and described in greater detail in the examples, below. The sets of nucleic acids described therein may be detected in whole or in part. For example, van't Veer et al. described a 70 gene set. The expression level of all 70 genes may be detected according to the methods and compositions described herein. Also, expression level of between 2 and 69 of the genes may be detected according to the methods and compositions described herein. In certain embodiments, the expression levels of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68 or 69 of the genes are detected according to the methods and compositions described herein.

The expression signatures of various disease states can be used to diagnose the presence of the disease. The expression signatures can also be used to develop and provide a prognosis for a patient suffering from a disease. The expression signatures can also be used to screen for possible biomarkers for disease or find potential drug targets.

The number of genes examined in order to make up a nucleic acid expression signature can be any number of genes greater than one. This includes 2-5,000 genes, 25-1000, 50-500, or 100-500. The number of genes examined can be 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149 or 150.

The nucleic acid molecules to be detected can be isolated from any type of biological sample. The sample can be a tissue sample that is formalin fixed and/or paraffin embedded or fresh frozen. Samples can be from tissue samples or samples of bodily fluid.

The reference sample can be made up of any type of nucleic acid molecule as long as it represents the target nucleic acids to be detected. Thus, the reference sample can be made up of nucleic acid molecules including RNA and DNA. RNA can include messenger RNA (mRNA), ribosomal RNA (rRNA), transfer RNA (tRNA), short interfering RNA (siRNA), micro RNA (miRNA), long non-coding RNA (lincRNA), viral RNA, in vitro transcribed RNA or any combination thereof. DNA can include genomic DNA or recombinant DNA. DNA can be single or double stranded. The reference sample can be made up of oligonucleotides or of artificially modified or tailored oligonucleotides (e.g. modifications to the base or backbones) as is well known in the art. In certain specific embodiments, the reference sample can be made up of a mixture of miRNA and mRNA.

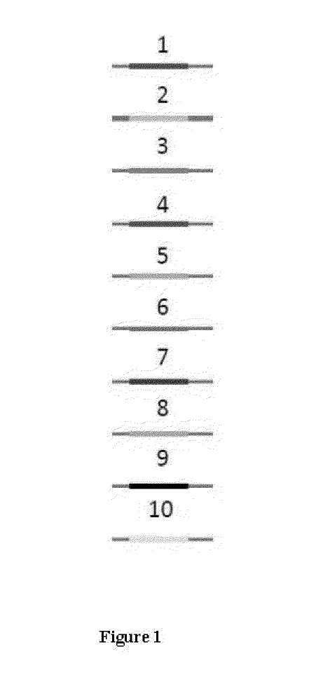

The reference sample can be a synthetic pool of nucleic acid molecules representing the target nucleic acid molecules provided at a defined concentration, as shown in FIG. 1A. The defined concentration can be the same concentration for every nucleic acid molecule in the reference sample. The defined concentration can also represent a normalized concentration of the corresponding target nucleic acid molecules represented in the reference sample. The reference sample can also include nucleic acid molecules that represent internal controls for the assay used to determine the expression levels of the target nucleic acid molecules. These internal controls can be housekeeping genes that are present in the sample with the target nucleic acid molecules.

The reference sample can include a synthetic pool of nucleic acid molecules. Each member of the pool represents a target nucleic acid molecule for a given assay and is present in a defined amount. In certain embodiments, the nucleic acid sequence of the members of the synthetic pool in the reference sample share a nucleic acid sequence with one of the target nucleic acid molecules. By sharing this sequence, the member of the pool can be specifically detected by a diagnostic nucleic acid molecule that also detects the corresponding target nucleic acid molecule. The sequence shared between a member of the synthetic pool of the reference sample and a target nucleic acid can be 100% identical. They can also be 85, 86, 87, 88, 89, 90, 91, 92, 93, 94, 95, 96, 97, 98 or 99% identical.

Multiple reference sample runs can be performed for each assay to insure correct normalization. 2, 3, 4, 5, 6, 7, 8, 9, or 10 runs of reference samples can be used per assay.

When a new reference sample is produced, it can be tested with probe nucleic acid molecules to be used in a particular assay. The signal for each diagnostic nucleic acid molecule can be normalized against the nucleic acid in the reference sample that corresponds with each target. The signal from the reference sample can be compared to a previously made reference sample. For a new lot of reference sample to be effective, it should have an average signal of 1 compared to a previously made reference sample with a standard deviation of less than 10%. If the average of 1 with a standard of deviation below 10% is not achieved, the new lot of reference sample can be adjusted to change the amount of any or all nucleic acid molecules in the reference sample to improve agreement with the previously made reference sample. The comparisons between the new and old lots of reference sample can be repeated until agreement is acceptable.

The amount of reference sample and corresponding target nucleic acid molecules present can be detected by any method known in the art. Examples of these methods are polymerase chain reaction (PCR) based analyses and probe array based analyses. In certain embodiments, these methods include using one or more probes that specifically bind to the target nucleic acid molecule in order to detect the presence and amount of the target nucleic acid molecule.

Probes or target nucleic acid molecules can be immobilized on a solid surface for detection. Appropriate solid surfaces include nitrocellulose and a gene chip array. Arrays can bind nucleic acids on beads, gels, polymeric surfaces, fibers (such as fiber optics), glass, or any other appropriate substrate.

Other detection methods include RT-PCR, ligase chain reaction, self sustained sequence replication, transcriptional amplification system, rolling circle amplification, quantitative PCR or any other nucleic acid amplification method, followed by the detection of the amplified molecules using techniques well known to those of skill in the art. These detection schemes are especially useful for the detection of nucleic acid molecules if such molecules are present in very low numbers.

According to certain embodiments, nanoreporters can be used to detect target nucleic acid molecules. Nanoreporters can be used according to the nanoreporter code system (nCounter® Analysis System). Both nanoreporters and the nCounter® Analysis System are described in greater detail below.

### Nanoreporters

Preferably, the nucleic acid probes used according to the methods of the disclosure are nanoreporters. A fully assembled and labeled nanoreporter comprises two main portions, a target-specific sequence that is capable of binding to a target molecule, and a labeled region which emits a “code” of signals (the “nanoreporter code”) associated with the target-specific sequence.

Upon binding of the nanoreporter to the target molecule, the nanoreporter code identifies the target molecule to which the nanoreporter is bound.

Many nanoreporters, referred to herein as singular nanoreporters, are composed of one molecular entity. However, to increase the specificity of a nanoreporter and/or to improve the kinetics of its binding to a target molecule, a preferred nanoreporter is a dual nanoreporter composed of two molecular entities, each containing a different target-specific sequence that binds to a different region of the same target molecule. A probe comprising nanoreporters is referred to herein as a “nanoReporter Probe.” In a dual nanoreporter, at least one of the two nanoReporter Probes is labeled. This labeled nanoReporter Probe is referred to herein as a “Reporter Probe.” The other nanoReporter Probe is not necessarily labeled. Such unlabeled components of dual nanoreporters are referred to herein as “Capture Probes” and often have affinity tags attached, such as biotin, which are useful to immobilize and/or stretch the complex containing the dual nanoreporter and the target molecule to allow visualization and/or imaging of the complex. When both probes are labeled or both have affinity tags, the probe with more label monomer attachment regions is referred to as the Reporter Probe and the other probe in the pair is referred to as a Capture Probe.

For both single and dual nanoreporters, a fully assembled and labeled nanoReporter Probe comprises two main portions, a target-specific sequence that is capable of binding to a target molecule, and a labeled portion which provides a “code” of signals associated with the target-specific sequence. Upon binding of the nanoReporter Probe to the target molecule, the code identifies the target molecule to which the nanoreporter is bound.

Nanoreporters are modular structures. In some embodiments, the nanoreporter comprises a plurality of different detectable molecules. In some embodiments, a labeled nanoreporter is a molecular entity containing certain basic elements: (i) a plurality of unique label attachment regions attached in a particular, unique linear combination, and (ii) complementary polynucleotide sequences attached to the label attachment regions of the backbone. In some embodiments, the labeled nanoreporter comprises 2, 3, 4, 5, 6, 7, 8, 9, 10 or more unique label attachment regions attached in a particular, unique linear combination, and complementary polynucleotide sequences attached to the label attachment regions of the backbone. In some embodiments, the labeled nanoreporter comprises 6 or more unique label attachment regions attached in a particular, unique linear combination, and complementary polynucleotide sequences attached to the label attachment regions of the backbone. A nanoReporter Probe further comprises a target-specific sequence, also attached to the backbone.

The term label attachment region includes a region of defined polynucleotide sequence within a given backbone that may serve as an individual attachment point for a detectable molecule. In some embodiments, the label attachment regions comprise designed sequences.

In some embodiments, the label nanoreporter also comprises a backbone containing a constant region. The term constant region includes tandemly-repeated sequences of about 10 to about 25 nucleotides that are covalently attached to a nanoreporter. The constant region can be attached at either the 5′ region or the 3′ region of a nanoreporter, and may be utilized for capture and immobilization of a nanoreporter for imaging or detection, such as by attaching to a solid substrate a sequence that is complementary to the constant region. In certain aspects, the constant region contains 2, 3, 4, 5, 6, 7, 8, 9, 10, or more tandemly-repeated sequences, wherein the repeat sequences each comprise about 8, 9, 10, 11, 12, 13, 14, 15, 16, 17, 18, 19, 20, 21, 22, 23, 24, 25, 26, 27, 28, 29, 30, or more nucleotides, including about 12-18, 13-17, or about 14-16 nucleotides.

The nanoreporters described herein can comprise synthetic, designed sequences. In some embodiments, the sequences contain a fairly regularly-spaced pattern of a nucleotide (e.g. adenine) residue in the backbone. In some embodiments, a nucleotide is spaced at least an average of 8, 9, 10, 12, 15, 16, 20, 30, or 50 bases apart. In some embodiments, a nucleotide is spaced at least an average of 8 to 16 bases apart. In some embodiments, a nucleotide is spaced at least an average of 8 bases apart. This allows for a regularly spaced complementary nucleotide in the complementary polynucleotide sequence having attached thereto a detectable molecule. For example, in some embodiments, when the nanoreporter sequences contain a fairly regularly-spaced pattern of adenine (A) residues in the backbone, whose complement is a regularly-spaced pattern of uridine (U) residues in complementary RNA segments, the in vitro transcription of the segments can be done using an aminoallyl-modified uridine base, which allows the covalent amine coupling of dye molecules at regular intervals along the segment. In some embodiments, the sequences contain about the same number or percentage of a nucleotide (e.g. adenine) that is spaced at least an average of 8, 9, 10, 12, 15, 16, 20, 30, or 50 bases apart in the sequences. This allows for similar number or percentages in the complementary polynucleotide sequence having attached thereto a detectable molecule. Thus, in some embodiments, the sequences contain a nucleotide that is not regularly-spaced but that is spaced at least an average of 8, 9, 10, 12, 15, 16, 20, 30, or 50 bases apart. In some embodiments, 20%, 30%, 50%, 60%, 70%, 80%, 90% or 100% of the complementary nucleotide is coupled to a detectable molecule. For instance, in some embodiments, when the nanoreporter sequences contain a similar percentage of adenine residues in the backbone and the in vitro transcription of the complementary segments is done using an aminoallyl-modified uridine base, 20%, 30%, 50%, 60%, 70%, 80%, 90% or 100% of the aminoallyl-modified uridine base can be coupled to a detectable molecule. Alternatively, the ratio of aminoallyl-modified uridine bases and uridine bases can be changed during the in vitro transcription process to achieve the desired number of sites which can be attached to a detectable molecule. For example, in vitro transcription process can take place in the presence of a mixture with a ratio of 1/1 of uridine to aminoallyl-modified uridine bases, when some or all the aminoallyl-modified uridine bases can be coupled to a detectable molecule.

In some embodiments, the nanoreporters described herein have a fairly consistent melting temperature (Tₘ). Without intending to be limited to any theory, the Tₘ of the nanoreporters described herein provides for strong bonds between the nanoreporter backbone and the complementary polynucleotide sequence having attached thereto a detectable molecule, therefore, preventing dissociation during synthesis and hybridization procedures. In addition, the consistent Tₘ among a population of nanoreporters allows for the synthesis and hybridization procedures to be tightly optimized, as the optimal conditions are the same for all spots and positions. In some embodiments, the sequences of the nanoreporters have a 50% guanine/cytosine (G/C), with no more than three G's in a row. Thus, in some embodiments, the disclosure provides a population of nanoreporters in which the Tₘ among the nanoreporters in the population is fairly consistent. In some embodiments, the disclosure provides a population of nanoreporters in which the Tₘ of the complementary polynucleotide sequences when hybridized to its label attachment regions is about 80° Celsius (C.), 85° C., 90° C., 100° C. or higher. In some embodiments, the disclosure provides a population of nanoreporters in which the Tₘ of the complementary polynucleotide sequences when hybridized to its label attachment regions is about 80° C. or higher.

In some embodiments, the nanoreporters described herein have minimal or no secondary structures, such as any stable intra-molecular base-paring interaction (e.g. hairpins). Without intending to be limited to any theory, the minimal secondary structure in the nanoreporters provides for better hybridization between the nanoreporter backbone and the polynucleotide sequence having attached thereto a detectable molecule. In addition, the minimal secondary structure in the nanoreporters provides for better detection of the detectable molecules in the nanoreporters. In some embodiments, the nanoreporters described herein have no significant intra-molecular pairing under annealing conditions of 75° C., 1×SSPE. Secondary structures can be predicted by programs known in the art such as MFOLD. In some embodiments, the nanoreporters described herein contain less than 1% of inverted repeats in each strand, wherein the inverted repeats are 9 bases or greater. In some embodiments, the nanoreporters described herein contain no inverted repeats in each strand. In some embodiments, the nanoreporters do not contain any inverted repeat of 9 nucleotides or greater across a sequence that is 1100 base pairs in length. In some embodiments, the nanoreporters do not contain any inverted repeat of 7 nucleotides or greater across any 100-base pair region. In some embodiments, the nanoreporters described herein contain less than 1% of inverted repeats in each strand, wherein the inverted repeats are 9 nucleotides or greater across a sequence that 1100 base pairs in length. In some embodiments, the nanoreporters described herein contain less than 1% of inverted repeats in each strand, wherein the inverted repeats are 7 nucleotides or greater across any 100-base pair region. In some embodiments, the nanoreporters described herein contain a skewed strand-specific content such that one strand is CT-rich and the other is GA-rich.

The disclosure also provides unique nanoreporters. In some embodiments, the nanoreporters described herein contain less that 1% of direct repeats. In some embodiments, the nanoreporters described herein contain no direct repeats. In some embodiments, the nanoreporters do not contain any direct repeat of 9 nucleotides or greater across a sequence that 1100 base pairs in length. In some embodiments, the labeled nanoreporters do not contain any direct repeat of 7 nucleotides or greater across any 100-base pair region. In some embodiments, the nanoreporters described herein contain less than 1% of direct repeats in each strand, wherein the direct repeats are 9 nucleotides or greater across a sequence that 1100 base pairs in length. In some embodiments, the nanoreporters described herein contain less than 1% of direct repeats in each strand, wherein the direct repeats are 7 nucleotides or greater across any 100-base pair region. In some embodiments, the nanoreporters described herein contain less than 85, 80, 70, 60, 50, 40, 30, 20, 10, or 5% homology to any other sequence used in the backbones or to any sequence described in the REFSEQ public database. In some embodiments, the nanoreporters described herein contain less than 85% homology to any other sequence used in the backbones or to any sequence described in the REFSEQ public database. In some embodiments, the nanoreporters described herein contain less than 20, 16, 15, 10, 9, 7, 5, 3, or 2 contiguous bases of homology to any other sequence used in the backbones or to any sequence described in the REFSEQ public database. In some embodiments, the nanoreporters described herein have no more than 15 contiguous bases of homology and no more than 85% identity across the entire length of the nanoreporter to any other sequence used in the backbones or to any sequence described in the REFSEQ public database.

In some embodiments, the sequence characteristics of the nanoReporter Probes described herein provide sensitive detection of a target molecule. For instance, the binding of the nanoReporter Probes to target molecules which results in the identification of the target molecules can be performed by individually detecting the presence of the nanoreporter. This can be performed by individually counting the presence of one or more of the nanoreporter molecules in a sample.

The complementary polynucleotide sequences attached to a nanoreporter backbone serve to attach detectable molecules, or label monomers, to the nanoreporter backbone. The complementary polynucleotide sequences may be directly labeled, for example, by covalent incorporation of one or more detectable molecules into the complementary polynucleotide sequence. Alternatively, the complementary polynucleotide sequences may be indirectly labeled, such as by incorporation of biotin or other molecule capable of a specific ligand interaction into the complementary polynucleotide sequence. In such instances, the ligand (e.g., streptavidin in the case of biotin incorporation into the complementary polynucleotide sequence) may be covalently attached to the detectable molecule. Where the detectable molecules attached to a label attachment region are not directly incorporated into the complementary polynucleotide sequence, this sequence serves as a bridge between the detectable molecule and the label attachment region, and may be referred to as a bridging molecule, e.g., a bridging nucleic acid.

The nucleic-acid based nanoreporter and nanoreporter-target complexes described herein comprise nucleic acids, which may be affinity-purified or immobilized using a nucleic acid, such as an oligonucleotide, that is complementary to the constant region or the nanoreporter or target nucleic acid. As noted above, in some embodiments the nanoreporters comprise at least one constant region, which may serve as an affinity tag for purification and/or for immobilization (for example to a solid surface). The constant region typically comprises two or more tandemly-repeated regions of repeat nucleotides, such as a series of 15-base repeats. In such exemplary embodiments, the nanoreporter, whether complexed to a target molecule or otherwise, can be purified or immobilized by an affinity reagent coated with a 15-base oligonucleotide which is the reverse complement of the repeat unit.

Nanoreporters, or nanoreporter-target molecule complexes, can be purified in two or more affinity selection steps. For example, in a dual nanoreporter, one probe can comprise a first affinity tag and the other probe can comprise a second (different) affinity tag. The probes are mixed with target molecules, and complexes comprising the two probes of the dual nanoreporter are separated from unbound materials (e.g., the target or the individual probes of the nanoreporter) by affinity purification against one or both individual affinity tags. In the first step, the mixture can be bound to an affinity reagent for the first affinity tag, so that only probes comprising the first affinity tag and the desired complexes are purified. The bound materials are released from the first affinity reagent and optionally bound to an affinity reagent for the second affinity tag, allowing the separation of complexes from probes comprising the first affinity tag. At this point only full complexes would be bound. The complexes are finally released from the affinity reagent for the second affinity tag and then preferably stretched and imaged. The affinity reagent can be any solid surface coated with a binding partner for the affinity tag, such as a column, bead (e.g., latex or magnetic bead) or slide coated with the binding partner. Immobilizing and stretching nanoreporters using affinity reagents is fully described in U.S. Publication No. 2010/0161026, which is incorporated by reference herein in its entirety.

The sequence of signals provided by the label monomers associated with the various label attachment regions of the backbone of a given nanoreporter allows for the unique identification of the nanoreporter. For example, when using fluorescent labels, a nanoreporter having a unique identity or unique spectral signature is associated with a target-specific sequence that recognizes a specific target molecule or a portion thereof. When a nanoreporter is exposed to a mixture containing the target molecule under conditions that permit binding of the target-specific sequence(s) of the nanoreporter to the target molecule, the target-specific sequence(s) preferentially bind(s) to the target molecule. Detection of the nanoreporter signal, such as the spectral code of a fluorescently labeled nanoreporter, associated with the nanoreporter allows detection of the presence of the target molecule in the mixture (qualitative analysis). Counting all the label monomers associated with a given spectral code or signature allows the counting of all the molecules in the mixture associated with the target-specific sequence coupled to the nanoreporter (quantitative analysis). Nanoreporters are thus useful for the diagnosis or prognosis of different biological states (e.g., disease vs. healthy) by quantitative analysis of known biological markers. Moreover, the exquisite sensitivity of individual molecule detection and quantification provided by the nanoreporters described herein allows for the identification of new diagnostic and prognostic markers, including those whose fluctuations among the different biological states is too slight detect a correlation with a particular biological state using traditional molecular methods. The sensitivity of nanoreporter-based molecular detection permits detailed pharmacokinetic analysis of therapeutic and diagnostic agents in small biological samples.

Many nanoreporters, referred to as singular nanoreporters, are composed of one molecular entity. However, to increase the specificity of a nanoreporter, a nanoreporter can be a dual nanoreporter composed of two molecular entities, each containing a different target-specific sequence that binds to a different region of the same target molecule. In a dual nanoreporter, at least one of the two molecular entities is labeled. The other molecular entity need not necessarily be labeled. Such unlabeled components of dual nanoreporters may be used as Capture Probes and optionally have affinity tags attached, such as biotin, which are useful to immobilize and/or stretch the complex containing the dual nanoreporter and the target molecule to allow visualization and/or imaging of the complex. For instance, in some embodiments, a dual nanoreporter with a 6-position nanoreporter code uses one 6-position coded nanoreporter (also referred to herein as a Reporter Probe) and a Capture Probe. In some embodiments, a dual nanoreporter with a 6-position nanoreporter code can be used, using one Capture Probe with an affinity tag and one 6-position nanoreporter component. In some embodiments an affinity tag is optionally included and can be used to purify the nanoreporter or to immobilize the nanoreporter (or nanoreporter-target molecule complex) for the purpose of imaging.

In some embodiments, the nucleotide sequences of the individual label attachment regions within each nanoreporter are different from the nucleotide sequences of the other label attachment regions within that nanoreporter, preventing rearrangements, such recombination, sharing or swapping of the label polynucleotide sequences. The number of label attachment regions to be formed on a backbone is based on the length and nature of the backbone, the means of labeling the nanoreporter, as well as the type of label monomers providing a signal to be attached to the label attachment regions of the backbone. In some embodiments, the complementary nucleotide sequence of each label attachment region is assigned a specific detectable molecule.

The disclosure also provides labeled nanoreporters wherein one or more label attachment regions are attached to a corresponding detectable molecule, each detectable molecule providing a signal. For example, in some embodiments, a labeled nanoreporter according to the disclosure is obtained when at least three detectable molecules are attached to three corresponding label attachment regions of the backbone such that these labeled label attachment regions, or spots, are distinguishable based on their unique linear arrangement. A “spot,” in the context of nanoreporter detection, is the aggregate signal detected from the label monomers attached to a single label attachment site on a nanoreporter, and which, depending on the size of the label attachment region and the nature (e.g., primary emission wavelength) of the label monomer, may appear as a single point source of light when visualized under a microscope. Spots from a nanoreporter may be overlapping or non-overlapping. The nanoreporter code that identifies that target molecule can comprise any permutation of the length of a spot, its position relative to other spots, and/or the nature (e.g., primary emission wavelength(s)) of its signal. Generally, for each probe or probe pair described herein, adjacent label attachment regions are non-overlapping, and/or the spots from adjacent label attachment regions are spatially and/or spectrally distinguishable, at least under the detection conditions (e.g., when the nanoreporter is immobilized, stretched and observed under a microscope, as described in U.S. Publication No. 2010/0112710, incorporated herein by reference).

Occasionally, reference is made to a spot size as a certain number of bases or nucleotides. As would be readily understood by one of skill in the art, this refers to the number of bases or nucleotides in the corresponding label attachment region.

The order and nature (e.g., primary emission wavelength(s), optionally also length) of spots from a nanoreporter serve as a nanoreporter code that identifies the target molecule capable of being bound by the nanoreporter through the nanoreporter's target specific sequence(s). When the nanoreporter is bound to a target molecule, the nanoreporter code also identifies the target molecule. Optionally, the length of a spot can be a component of the nanoreporter code.

Detectable molecules providing a signal associated with different label attachment regions of the backbone can provide signals that are indistinguishable under the detections conditions (“like” signals), or can provide signals that are distinguishable, at least under the detection conditions (e.g., when the nanoreporter is immobilized, stretched and observed under a microscope).

The disclosure also provides a nanoreporter wherein two or more detectable molecules are attached to a label attachment region. The signal provided by the detectable molecules associated with said label attachment region produces an aggregate signal that is detected. The aggregate signal produced may be made up of like signals or made up of at least two distinguishable signals (e.g., spectrally distinguishable signals).

In one embodiment, a nanoreporter includes at least three detectable molecules providing like signals attached to three corresponding label attachment regions of the backbone and said three detectable molecules are spatially distinguishable. In another embodiment, a nanoreporter includes at least three detectable molecules providing three distinguishable signals attached to three neighboring label attachment regions, for example three adjacent label attachment regions, whereby said at least three label monomers are spectrally distinguishable.

In other embodiments, a nanoreporter includes spots providing like or unlike signals separated by a spacer region, whereby interposing the spacer region allows the generation of dark spots, which expand the possible combination of uniquely detectable signals. The term “dark spot” refers to a lack of signal from a label attachment site on a nanoreporter. Dark spots can be incorporated into the nanoreporter code to add more coding permutations and generate greater nanoreporter diversity in a nanoreporter population. In one embodiment, the spacer regions have a length determined by the resolution of an instrument employed in detecting the nanoreporter.

In other embodiments, a nanoreporter includes one or more “double spots.” Each double spot contains two or more (e.g., three, four or five) adjacent spots that provide like signals without being separated by a spacer region. Double spots can be identified by their sizes.

A detectable molecule providing a signal described herein may be attached covalently or non-covalently (e.g., via hybridization) to a complementary polynucleotide sequence that is attached to the label attachment region. The label monomers may also be attached indirectly to the complementary polynucleotide sequence, such as by being covalently attached to a ligand molecule (e.g., streptavidin) that is attached through its interaction with a molecule incorporated into the complementary polynucleotide sequence (e.g., biotin incorporated into the complementary polynucleotide sequence), which is in turn attached via hybridization to the backbone.

A nanoreporter can also be associated with a uniquely detectable signal, such as a spectral code, determined by the sequence of signals provided by the label monomers attached (e.g., indirectly) to label attachment regions on the backbone of the nanoreporter, whereby detection of the signal allows identification of the nanoreporter.

In other embodiments, a nanoreporter also includes an affinity tag attached to the Reporter Probe backbone, such that attachment of the affinity tag to a support allows backbone stretching and resolution of signals provided by label monomers corresponding to different label attachment regions on the backbone. Nanoreporter stretching may involve any stretching means known in the art including but not limited to, means involving physical, hydrodynamic or electrical means. The affinity tag may comprise a constant region.

In other embodiments, a nanoreporter also includes a target-specific sequence coupled to the backbone. The target-specific sequence is selected to allow the nanoreporter to recognize, bind or attach to a target molecule. The nanoreporters described herein are suitable for identification of target molecules of all types. For example, appropriate target-specific sequences can be coupled to the backbone of the nanoreporter to allow detection of a target molecule. Preferably the target molecule is DNA or RNA.

One embodiment of the disclosure provides increased flexibility in target molecule detection with label monomers described herein. In this embodiment, a dual nanoreporter comprising two different molecular entities, each with a separate target-specific region, at least one of which is labeled, bind to the same target molecule. Thus, the target-specific sequences of the two components of the dual nanoreporter bind to different portions of a selected target molecule, whereby detection of the spectral code associated with the dual nanoreporter provides detection of the selected target molecule in a biomolecular sample contacted with said dual nanoreporter.

The disclosure also provides a method of detecting the presence of a specific target molecule in a biomolecular sample comprising: (i) contacting said sample with a nanoreporter as described herein (e.g., a singular or dual nanoreporter) under conditions that allow binding of the target-specific sequences in the dual nanoreporter to the target molecule and (ii) detecting the spectral code associated with the dual nanoreporter. Depending on the nanoreporter architecture, the dual nanoreporter may be labeled before or after binding to the target molecule.

The uniqueness of each nanoReporter Probe in a population of probes allows for the multiplexed analysis of a plurality of target molecules. For example, in some embodiments, each nanoReporter Probe contains six label attachment regions, where each label attachment region of each backbone is different from the other label attachment regions in that same backbone. If the label attachment regions are going to be labeled with one of four colors and there are 24 possible unique sequences for the label attachment regions and each label attachment region is assigned a specific color, each label attachment region in each backbone will consist of one of four sequences. There will be 4096 possible nanoreporters in this example. The number of possible nanoreporters can be increased, for example, by increasing the number of colors, increasing the number of unique sequences for the label attachment regions and/or increasing the number of label attachment regions per backbone. Likewise the number of possible nanoreporters can be decreased by decreasing the number of colors, decreasing the number of unique sequences for the label attachment regions and/or decreasing the number of label attachment regions per backbone.

In certain embodiments, the methods of detection are performed in multiplex assays, whereby a plurality of target molecules is detected in the same assay (a single reaction mixture). In a preferred embodiment, the assay is a hybridization assay in which the plurality of target molecules is detected simultaneously. In certain embodiments, the plurality of target molecules detected in the same assay is, at least 2 different target molecules, at least 5 different target molecules, at least 10 different target molecules, at least 20 different target molecules, at least 50 different target molecules, at least 75 different target molecules, at least 100 different target molecules, at least 200 different target molecules, at least 500 different target molecules, at least 750 different target molecules, or at least 1000 different target molecules. In other embodiments, the plurality of target molecules detected in the same assay is up to 50 different target molecules, up to 100 different target molecules, up to 150 different target molecules, up to 200 different target molecules, up to 300 different target molecules, up to 500 different target molecules, up to 750 different target molecules, up to 1000 different target molecules, up to 2000 different target molecules, or up to 5000 different target molecules. In yet other embodiments, the plurality of target molecules detected is any range in between the foregoing numbers of different target molecules, such as, but not limited to, from 20 to 50 different target molecules, from 50 to 200 different target molecules, from 100 to 1000 different target molecules, from 500 to 5000 different target molecules, and so on and so forth.

nCounter®

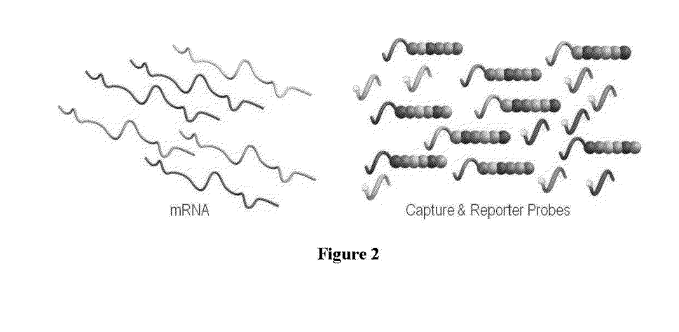

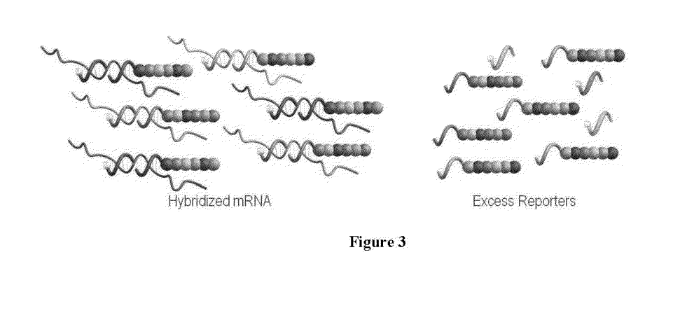

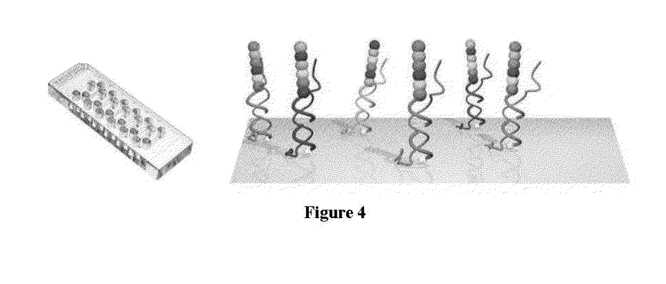

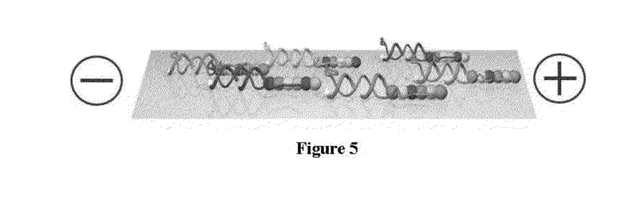

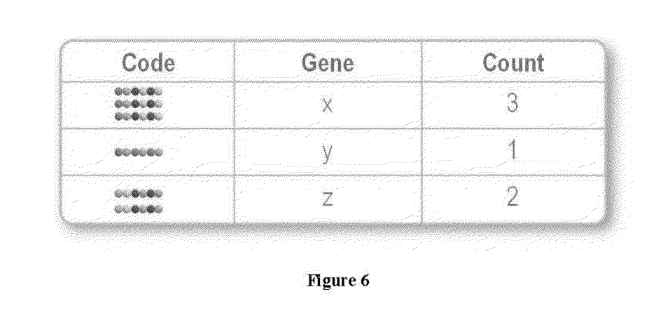

The NanoString nCounter® Analysis System can be used to determine the expression levels of any or all of the genes described above. The NanoString nCounter® Analysis System (also referred to, herein, as the nanoreporter code system) delivers direct, multiplexed measurements of gene expression through digital readouts of the relative abundance of hundreds of mRNA transcripts. The nCounter® Analysis System uses gene-specific probe pairs that hybridize directly to the mRNA sample in solution, eliminating any enzymatic reactions that might introduce bias in the results (FIG. 2). After hybridization, all of the sample processing steps are automated on the nCounter® Prep Station. First, excess capture and Reporter Probes are removed (FIG. 3), followed by binding of the probe-target complexes to random locations on the surface of the nCounter® cartridge via a streptavidin-biotin linkage (FIG. 4). Finally, probe/target complexes are aligned and immobilized in the nCounter® sample cartridge (FIG. 5). The Reporter Probe carries the fluorescent signal; the Capture Probe allows the complex to be immobilized for data collection. Up to 800 pairs of probes, each specific to a particular gene, can be combined with a series of internal controls to form a CodeSet. After sample processing has completed, sample cartridges are placed in the nCounter® Digital Analyzer for data collection. Each target molecule of interest is identified by the “color code” generated by six ordered fluorescent spots present on the Reporter Probe. The Reporter Probes on the surface of the cartridge are then counted and tabulated for each target molecule (FIG. 6).

The nCounter® Analysis System is comprised of two instruments, the nCounter® Prep Station used for post-hybridization processing, and the Digital Analyzer used for data collection and analysis. The assay also requires a heat block and microcentrifuge for RNA extraction and a low-volume spectrophotometer for measuring the concentration and purity of the RNA output. A heat block with a heated lid is required to run the hybridization at a constant elevated temperature, and a swinging bucket centrifuge is required for spinning the Prep Plates prior to insertion into the Prep Station.

The nCounter® Prep Station is an automated fluid handling robot that processes samples post-hybridization to prepare them for data collection on the nCounter® Digital Analyzer. Prior to processing on the Prep Station, total RNA or alternatively other RNA molecules extracted from FFPE (Formalin-Fixed, Paraffin-Embedded) tissue samples, or other sample types, are hybridized with the Reporter Probes and Capture Probes according to the nCounter® protocol. Hybridization to the target RNA is driven by excess probes. To accurately analyze these hybridized molecules they are first purified from the remaining excess probes in the hybridization reaction. The Prep Station isolates the hybridized mRNA molecules from the excess Reporter and Capture Probes using two sequential magnetic bead purification steps. These affinity purifications utilize custom oligonucleotide-modified magnetic beads that retain only the tripartite complexes of mRNA molecules that are bound to both a Capture Probe and a Reporter Probe. Next, this solution of tripartite complexes is washed through a flow cell in the NanoString sample cartridge. One surface of this flow cell is coated with a polyethylene glycol (PEG) hydrogel that is densely impregnated with covalently bound streptavidin. As the solution passes through the flow cell, the tripartite complexes are bound to the streptavidin in the hydrogel through biotin molecules that are incorporated into each Capture Probe. The PEG hydrogel acts not only to provide a streptavidin-dense surface onto which the tripartite complexes can be specifically bound, but also inhibits the non-specific binding of any remaining excess Reporter Probes.

After the complexes are bound to the flow cell surface, an electric field is applied along the length of each sample cartridge flow cell to facilitate the optical identification and order of the fluorescent spots that make up each Reporter Probe. Because the Reporter Probes are charged nucleic acids, the applied voltage imparts a force on them that uniformly stretches and orients them along the electric field. While the voltage is applied, the Prep Station adds an immobilization reagent that locks the reporters in the elongated configuration after the field is removed. Once the reporters are immobilized the cartridge can be transferred to the nCounter® Digital Analyzer for data collection. All consumable components and reagents required for sample processing on the Prep Station are provided in the nCounter® Master Kit. These reagents are ready to load on the deck of the nCounter® Prep Station which can process a sample cartridge containing 12 flow cells per run in approximately 2 hours. The 12 flow cells can comprise a mixture of test samples and reference samples as required for the particular test.

The nCounter® Digital Analyzer collects data by taking images of the immobilized fluorescent reporters in the sample cartridge with a CCD camera through a microscope objective lens. Because the fluorescent Reporter Probes are small, single molecule barcodes with features smaller than the wavelength of visible light, the Digital Analyzer uses high magnification, diffraction-limited imaging to resolve the sequence of the spots in the fluorescent barcodes. The Digital Analyzer captures hundreds of consecutive fields of view (FOV) that can each contain hundreds or thousands of discrete Reporter Probes. Each FOV is a combination of four monochrome images captured at different wavelengths. The resulting overlay can be thought of as a four-color image in blue, green, yellow, and red. Each 4-color FOV is captured in just a few seconds and processed in real time to provide a “count” for each fluorescent barcode in the sample. Because each barcode specifically identifies a single mRNA molecule or other nucleic acid molecule tested, the resultant data from the Digital Analyzer is an accurate inventory of the abundance of each mRNA or nucleic acid of interest in a biological sample (FIG. 6).

The resulting test sample data from the Digital Analyzer are normalized to the reference sample data to generate a test result. Other transformations may be included as part of the algorithm in order to generate a test result, but in the described method, at least one of the steps includes a normalization of the test sample data to the reference sample.

### Kits

The disclosure also provides a diagnostic kit. The kit can include compositions for extraction of nucleic acid molecules from a sample. Any known compositions used for these extractions may be used. The kit can also include a set of probe nucleic acid molecules for detection of target nucleic acid molecules in a sample. The kit can also include a reference sample that incorporates a synthetic pool of nucleic acid molecules that correspond with the target nucleic acid molecules to be detected. Each of the nucleic acid molecules in the reference sample can be present in a known amount. The kit can also include reagents for hybridization, purification, immobilization and imaging of diagnostic nucleic acid molecules as well as any algorithm and/or software that would be necessary to normalize test sample signal to reference sample signal.

### EXAMPLES

### Example 1

### Design and Synthesis of a Multi-Gene Reference Sample

This example describes a reference sample consisting of 58 nucleic acid target genes. The design of the reference sample along with each of the steps required to produce the reference sample for use in a multivariate gene assay are described below. While the description below is directed to 58 nucleic acid target genes, it is understood that one of ordinary skill in the art following these provided teachings can design reference samples to other nucleic acids. The application of the reference sample for detecting the 58 target genes is described in a separate example below.

Plasmid Construction and Synthesis for the 58 Nucleic Acid Target Genes

All 58 reference sample plasmids were constructed in the same 3171 bp vector backbone, a proprietary derivative of pUC119 prepared by Blue Heron Biotechnology. The plasmids were prepared, transformed into E. coli, and purified by Blue Heron Biotechnology. Both purified plasmid and E. coli stabs were provided. Each of the 58 plasmids has a unique 279 bp insert that corresponds to a fragment of the gene sequence (i.e. nucleic acid target) of interest, inserted between the 3′ CTTTC and 5′ GAAAG, as per Table 1. The plasmid name shown in the table includes the gene name in all capital letters.

TABLE 1

| Plasmid | |
|---|---|
| Name | Plasmid Insert Sequence (5′-3′) |
| pFOXA1ref | GCATGCTAATACGACTCACTATAGGCGCTCGGGTGACTGCAGCTGCT |
| | CAGCTCCCCTCCCCCGCCCCGCGCCGCGCGGCCGCCCGTCGCTTCGC |
| | ACAGGGCTGGATGGTTGTATTGGGCAGGGTGGCTCCAGGATGTTAGG |
| | AACTGTGAAGATGGAAGGGCATGAAACCAGCGACTGGAACAGCTAC |
| | TACGCAGACACGCAGGAGGCCTACTCCTCCGTCCCGGTCAGCAACAT |
| | GAACTCAGGCCTGGGCTCCATGAACTCCATGAACACCTATCTAGA |
| | (SEQ ID NO: 1) |
| pKRT5ref | GCATGCTAATACGACTCACTATAGGCATCACCGTTCCTGGGTAACAG |
| | AGCCACCTTCTGCGTCCTGCTGAGCTCTGTTCTCTCCAGCACCTCCCA |
| | ACCCACTAGTGCCTGGTTCTCTTGCTCCACCAGGAACAAGCCACCAT |
| | GTCTCGCCAGTCAAGTGTGTCCTTCCGGAGCGGGGGCAGTCGTAGCT |
| | TCAGCACCGCCTCTGCCATCACCCCGTCTGTCTCCCGCACCAGCTTCA |
| | CCTCCGTGTCCCGGTCCGGGGGTGGCGGTGGTGGTGTCTAGA |
| | (SEQ ID NO: 2) |
| pBCL2ref | GCATGCTAATACGACTCACTATAGAAAAAAAGATTTATTTATTTAAG |
| | ACAGTCCCATCAAAACTCCTGTCTTTGGAAATCCGACCACTAATTGCC |
| | AAGCACCGCTTCGTGTGGCTCCACCTGGATGTTCTGTGCCTGTAAACA |
| | TAGATTCGCTTTCCATGTTGTTGGCCGGATCACCATCTGAAGAGCAG |
| | ACGGATGGAAAAAGGACCTGATCATTGGGGAAGCTGGCTTTCTGGCT |
| | GCTGGAGGCTGGGGAGAAGGTGTTCATTCACTTGCATCTAGA |
| | (SEQ ID NO: 3) |
| pBIRC5ref | GCATGCTAATACGACTCACTATAGGCTTTCTTATTTTGTTTGAATTGT |
| | TAATTCACAGAATAGCACAAACTACAATTAAAACTAAGCACAAAGCC |
| | ATTCTAAGTCATTGGGGAAACGGGGTGAACTTCAGGTGGATGAGGAG |
| | ACAGAATAGAGTGATAGGAAGCGTCTGGCAGATACTCCTTTTGCCAC |
| | TGCTGTGTGATTAGACAGGCCCAGTGAGCCGCGGGGCACATGCTGGC |
| | CGCTCCTCCCTCAGAAAAAGGCAGTGGCCTAAATCCTTCTAGA |
| | (SEQ ID NO: 4) |
| pGPR160ref | GCATGCTAATACGACTCACTATAGATTATTGCCTGAATTTCTCTAAAA |
| | CAACCAAGCTTTCATTTAAGTGTCAAAAATTATTTTATTTCTTTACAG |
| | TAATTTTAATTTGGATTTCAGTCCTTGCTTATGTTTTGGGAGACCCAG |
| | CCATCTACCAAAGCCTGAAGGCACAGAATGCTTATTCTCGTCACTGT |
| | CCTTTCTATGTCAGCATTCAGAGTTACTGGCTGTCATTTTTCATGGTG |
| | ATGATTTTATTTGTAGCTTTCATAACCTGTTGGGTCTAGA |
| | (SEQ ID NO: 5) |
| pCEP55ref | GCATGCTAATACGACTCACTATAGAAGAATGCTTATCAACTCACAGA |
| | GAAGGACAAAGAAATACAGCGACTGAGAGACCAACTGAAGGCCAGA |
| | TATAGTACTACCGCATTGCTTGAACAGCTGGAAGAGACAACGAGAGA |
| | AGGAGAAAGGAGGGAGCAGGTGTTGAAAGCCTTATCTGAAGAGAAA |
| | GACGTATTGAAACAACAGTTGTCTGCTGCAACCTCACGAATTGCTGA |
| | ACTTGAAAGCAAAACCAATACACTCCGTTTATCACAGACTTCTAGA |
| | (SEQ ID NO: 6) |
| pTYMSref | GCATGCTAATACGACTCACTATAGATGAATTCCCTCTGCTGACAACC |
| | AAACGTGTGTTCTGGAAGGGTGTTTTGGAGGAGTTGCTGTGGTTTATC |
| | AAGGGATCCACAAATGCTAAAGAGCTGTCTTCCAAGGGAGTGAAAA |
| | TCTGGGATGCCAATGGATCCCGAGACTTTTTGGACAGCCTGGGATTC |
| | TCCACCAGAGAAGAAGGGGACTTGGGCCCAGTTTATGGCTTCCAGTG |
| | GAGGCATTTTGGGGCAGAATACAGAGATATGGAATCAGTCTAGA |
| | (SEQ ID NO: 7) |
| pSLC39A6ref | GCATGCTAATACGACTCACTATAGATGTGGAGATTAAGAAGCAGTTG |
| | TCCAAGTATGAATCTCAACTTTCAACAAATGAGGAGAAAGTAGATAC |
| | AGATGATCGAACTGAAGGCTATTTACGAGCAGACTCACAAGAGCCCT |
| | CCCACTTTGATTCTCAGCAGCCTGCAGTCTTGGAAGAAGAAGAGGTC |
| | ATGATAGCTCATGCTCATCCACAGGAAGTCTACAATGAATATGTACC |
| | CAGAGGGTGCAAGAATAAATGCCATTCACATTTCCACGTCTAGA |
| | (SEQ ID NO: 8) |
| pSFRP1ref | GCATGCTAATACGACTCACTATAGATTCTCCCGGGGGCAGGGTGGGG |
| | AGGGAGCCTCGGGTGGGGTGGGAGCGGGGGGGACAGTGCCCCGGGA |
| | ACCCGGTGGGTCACACACACGCACTGCGCCTGTCAGTAGTGGACATT |
| | GTAATCCAGTCGGCTTGTTCTTGCAGCATTCCCGCTCCCTTCCCTCCA |
| | TAGCCACGCTCCAAACCCCAGGGTAGCCATGGCCGGGTAAAGCAAG |
| | GGCCATTTAGATTAGGAAGGTTTTTAAGATCCGCAATGTTCTAGA |
| | (SEQ ID NO: 9) |
| pMLPHref | GCATGCTAATACGACTCACTATAGGTTTCAGACATTGAATCCAGGAT |
| | TGCAGCCCTGAGGGCCGCAGGGCTCACGGTGAAGCCCTCGGGAAAG |
| | CCCCGGAGGAAGTCAAACCTCCCGATATTTCTCCCTCGAGTGGCTGG |
| | GAAACTTGGCAAGAGACCAGAGGACCCAAATGCAGACCCTTCAAGT |
| | GAGGCCAAGGCAATGGCTGTGCCCTATCTTCTGAGAAGAAAGTTCAG |
| | TAATTCCCTGAAAAGTCAAGGTAAAGATGATGATTCTTTTTCTAGA |
| | (SEQ ID NO: 10) |
| pCENPFref | GCATGCTAATACGACTCACTATAGAAGAACAACCATGGCAACTCGGA |
| | CCAGCCCCCGCCTGGCTGCACAGAAGTTAGCGCTATCCCCACTGAGT |
| | CTCGGCAAAGAAAATCTTGCAGAGTCCTCCAAACCAACAGCTGGTGG |
| | CAGCAGATCACAAAAGGTCAAAGTTGCTCAGCGGAGCCCAGTAGATT |
| | CAGGCACCATCCTCCGAGAACCCACCACGAAATCCGTCCCAGTCAAT |
| | AATCTTCCTGAGAGAAGTCCGACTGACAGCCCCAGAGATCTAGA |
| | (SEQ ID NO: 11) |
| pKRT14ref | GCATGCTAATACGACTCACTATAGGAGCAGGAGATCGCCACCTACCG |
| | CCGCCTGCTGGAGGGCGAGGACGCCCACCTCTCCTCCTCCCAGTTCTC |
| | CTCTGGATCGCAGTCATCCAGAGATGTGACCTCCTCCAGCCGCCAAA |
| | TCCGCACCAAGGTCATGGATGTGCACGATGGCAAGGTGGTGTCCACC |
| | CACGAGCAGGTCCTTCGCACCAAGAACTGAGGCTGCCCAGCCCCGCT |
| | CAGGCCTAGGAGGCCCCCCGTGTGGACACAGATCCCATCTAGA |
| | (SEQ ID NO: 12) |
| pRRM2ref | GCATGCTAATACGACTCACTATAGAAAACCCCCGCCGCTTTGTCATCT |
| | TCCCCATCGAGTACCATGATATCTGGCAGATGTATAAGAAGGCAGAG |
| | GCTTCCTTTTGGACCGCCGAGGAGGTTGACCTCTCCAAGGACATTCA |
| | GCACTGGGAATCCCTGAAACCCGAGGAGAGATATTTTATATCCCATG |
| | TTCTGGCTTTCTTTGCAGCAAGCGATGGCATAGTAAATGAAAACTTG |
| | GTGGAGCGATTTAGCCAAGAAGTTCAGATTACAGAAGTCTAGA |
| | (SEQ ID NO: 13) |
| pFOXC1ref | GCATGCTAATACGACTCACTATAGGCCGCCTCACCTCGTGGTACCTG |
| | AACCAGGCGGGCGGAGACCTGGGCCACTTGGCAAGCGCGGCGGCGG |
| | CGGCGGCGGCCGCAGGCTACCCGGGCCAGCAGCAGAACTTCCACTCG |
| | GTGCGGGAGATGTTCGAGTCACAGAGGATCGGCTTGAACAACTCTCC |
| | AGTGAACGGGAATAGTAGCTGTCAAATGGCCTTCCCTTCCAGCCAGT |
| | CTCTGTACCGCACGTCCGGAGCTTTCGTCTACGACTGTATCTAGA |
| | (SEQ ID NO: 14) |
| pCDC20ref | GCATGCTAATACGACTCACTATAGGGCACCAGCAGTGCTGAGGTGCA |
| | GCTATGGGATGTGCAGCAGCAGAAACGGCTTCGAAATATGACCAGTC |
| | ACTCTGCCCGAGTGGGCTCCCTAAGCTGGAACAGCTATATCCTGTCC |
| | AGTGGTTCACGTTCTGGCCACATCCACCACCATGATGTTCGGGTAGC |
| | AGAACACCATGTGGCCACACTGAGTGGCCACAGCCAGGAAGTGTGT |
| | GGGCTGCGCTGGGCCCCAGATGGACGACATTTGGCCAGTTCTAGA |
| | (SEQ ID NO: 15) |
| pPGRref | GCATGCTAATACGACTCACTATAGGCCGGATTCAGAAGCCAGCCAGA |
| | GCCCACAATACAGCTTCGAGTCATTACCTCAGAAGATTTGTTTAATCT |
| | GTGGGGATGAAGCATCAGGCTGTCATTATGGTGTCCTTACCTGTGGG |
| | AGCTGTAAGGTCTTCTTTAAGAGGGCAATGGAAGGGCAGCACAACTA |
| | CTTATGTGCTGGAAGAAATGACTGCATCGTTGATAAAATCCGCAGAA |
| | AAAACTGCCCAGCATGTCGCCTTAGAAAGTGCTGTCATCTAGA |
| | (SEQ ID NO: 16) |
| pGRB7ref | GCATGCTAATACGACTCACTATAGGCAGCTTTCCTGAGATCCAGGGC |
| | TTTCTGCAGCTGCGGGGTTCAGGACGGAAGCTTTGGAAACGCTTTTTC |
| | TGCTTCTTGCGCCGATCTGGCCTCTATTACTCCACCAAGGGCACCTCT |
| | AAGGATCCGAGGCACCTGCAGTACGTGGCAGATGTGAACGAGTCCA |
| | ACGTGTACGTGGTGACGCAGGGCCGCAAGCTCTACGGGATGCCCACT |
| | GACTTCGGTTTCTGTGTCAAGCCCAACAAGCTTCGAATCTAGA |
| | (SEQ ID NO: 17) |
| pANLNref | GCATGCTAATACGACTCACTATAGAACCACCGTTTCCATCGTCTCGTA |
| | GTCCGACGCCTGGGGCGATGGATCCGTTTACGGAGAAACTGCTGGAG |
| | CGAACCCGTGCCAGGCGAGAGAATCTTCAGAGAAAAATGGCTGAGA |
| | GGCCCACAGCAGCTCCAAGGTCTATGACTCATGCTAAGCGAGCTAGA |
| | CAGCCACTTTCAGAAGCAAGTAACCAGCAGCCCCTCTCTGGTGGTGA |
| | AGAGAAATCTTGTACAAAACCATCGCCATCAAAAAAACTCTAGA |
| | (SEQ ID NO: 18) |
| pEGFRref | GCATGCTAATACGACTCACTATAGGCTCCCAGTACCTGCTCAACTGG |
| | TGTGTGCAGATCGCAAAGGGCATGAACTACTTGGAGGACCGTCGCTT |
| | GGTGCACCGCGACCTGGCAGCCAGGAACGTACTGGTGAAAACACCG |
| | CAGCATGTCAAGATCACAGATTTTGGGCTGGCCAAACTGCTGGGTGC |
| | GGAAGAGAAAGAATACCATGCAGAAGGAGGCAAAGTGCCTATCAAG |
| | TGGATGGCATTGGAATCAATTTTACACAGAATCTATACCCTCTAGA |
| | (SEQ ID NO: 19) |
| pMKI67ref | GCATGCTAATACGACTCACTATAGGTTATAAGCCCTCCAGCTCCTAGT |
| | CCTAGGAAAACTCCAGTTGCCAGTGATCAACGCCGTAGGTCCTGCAA |
| | AACAGCCCCTGCTTCCAGCAGCAAATCTCAGACAGAGGTTCCTAAGA |
| | GAGGAGGAGAAAGAGTGGCAACCTGCCTTCAAAAGAGAGTGTCTAT |
| | CAGCCGAAGTCAACATGATATTTTACAGATGATATGTTCCAAAAGAA |
| | GAAGTGGTGCTTCGGAAGCAAATCTGATTGTTGCAAAATCTAGA |
| | (SEQ ID NO: 20) |
| pBAG1ref | GCATGCTAATACGACTCACTATAGAGGAGGTGACCAGGGAGGAAAT |
| | GGCGGCAGCTGGGCTCACCGTGACTGTCACCCACAGCAATGAGAAGC |
| | ACGACCTTCATGTTACCTCCCAGCAGGGCAGCAGTGAACCAGTTGTC |
| | CAAGACCTGGCCCAGGTTGTTGAAGAGGTCATAGGGGTTCCACAGTC |
| | TTTTCAGAAACTCATATTTAAGGGAAAATCTCTGAAGGAAATGGAAA |
| | CACCGTTGTCAGCACTTGGAATACAAGATGGTTGCCGGGTCTAGA |
| | (SEQ ID NO: 21) |
| pUBE2Tref | GCATGCTAATACGACTCACTATAGGTACCCCGTTGGTCCGCGCGTTG |
| | CTGCGTTGTGAGGGGTGTCAGCTCAGTGCATCCCAGGCAGCTCTTAG |
| | TGTGGAGCAGTGAACTGTGTGTGGTTCCTTCTACTTGGGGATCATGCA |
| | GAGAGCTTCACGTCTGAAGAGAGAGCTGCACATGTTAGCCACAGAGC |
| | CACCCCCAGGCATCACATGTTGGCAAGATAAAGACCAAATGGATGAC |
| | CTGCGAGCTCAAATATTAGGTGGAGCCAACACACCTTTCTAGA |
| | (SEQ ID NO: 22) |
| pMYBL2ref | GCATGCTAATACGACTCACTATAGGCACAACCACCTCAACCCTGAGG |
| | TGAAGAAGTCTTGCTGGACCGAGGAGGAGGACCGCATCATCTGCGA |
| | GGCCCACAAGGTGCTGGGCAACCGCTGGGCCGAGATCGCCAAGATG |
| | TTGCCAGGGAGGACAGACAATGCTGTGAAGAATCACTGGAACTCTAC |
| | CATCAAAAGGAAGGTGGACACAGGAGGCTTCTTGAGCGAGTCCAAA |
| | GACTGCAAGCCCCCAGTGTACTTGCTGCTGGAGCTCGAGGATCTAGA |
| | (SEQ ID NO: 23) |
| pMELKref | GCATGCTAATACGACTCACTATAGATTTGCCCCGGATCAAAACGGAG |
| | ATTGAGGCCTTGAAGAACCTGAGACATCAGCATATATGTCAACTCTA |
| | CCATGTGCTAGAGACAGCCAACAAAATATTCATGGTTCTTGAGTACT |
| | GCCCTGGAGGAGAGCTGTTTGACTATATAATTTCCCAGGATCGCCTG |
| | TCAGAAGAGGAGACCCGGGTTGTCTTCCGTCAGATAGTATCTGCTGT |
| | TGCTTATGTGCACAGCCAGGGCTATGCTCACAGGGACCTCTAGA |
| | (SEQ ID NO: 24) |
| pMYCref | GCATGCTAATACGACTCACTATAGGTCAAGTTGGACAGTGTCAGAGT |
| | CCTGAGACAGATCAGCAACAACCGAAAATGCACCAGCCCCAGGTCCT |
| | CGGACACCGAGGAGAATGTCAAGAGGCGAACACACAACGTCTTGGA |
| | GCGCCAGAGGAGGAACGAGCTAAAACGGAGCTTTTTTGCCCTGCGTG |
| | ACCAGATCCCGGAGTTGGAAAACAATGAAAAGGCCCCCAAGGTAGT |
| | TATCCTTAAAAAAGCCACAGCATACATCCTGTCCGTCCAATCTAGA |
| | (SEQ ID NO: 25) |
| pCDC6ref | GCATGCTAATACGACTCACTATAGATTCCTTCCCTCTTCAGCAGAAGA |
| | TCTTGGTTTGCTCTTTGATGCTCTTGATCAGGCAGTTGAAAATCAAAG |
| | AGGTCACTCTGGGGAAGTTATATGAAGCCTACAGTAAAGTCTGTCGC |
| | AAACAGCAGGTGGCGGCTGTGGACCAGTCAGAGTGTTTGTCACTTTC |
| | AGGGCTCTTGGAAGCCAGGGGCATTTTAGGATTAAAGAGAAACAAG |
| | GAAACCCGTTTGACAAAGGTGTTTTTCAAGATTGAAGTCTAGA |
| | (SEQ ID NO: 26) |
| pMlAref | GCATGCTAATACGACTCACTATAGGAGTGCAGCCACCCTATCTCCAT |
| | GGCTGTGGCCCTTCAGGACTACATGGCCCCCGACTGCCGATTCCTGA |
| | CCATTCACCGGGGCCAAGTGGTGTATGTCTTCTCCAAGCTGAAGGGC |
| | CGTGGGCGGCTCTTCTGGGGAGGCAGCGTTCAGGGAGATTACTATGG |
| | AGATCTGGCTGCTCGCCTGGGCTATTTCCCCAGTAGCATTGTCCGAGA |
| | GGACCAGACCCTGAAACCTGGCAAAGTCGATGTGAAGTCTAGA |
| | (SEQ ID NO: 27) |
| pPHGDHref | GCATGCTAATACGACTCACTATAGAACACCCCCAATGGGAACAGCCT |
| | CAGTGCCGCAGAACTCACTTGTGGAATGATCATGTGCCTGGCCAGGC |
| | AGATTCCCCAGGCGACGGCTTCGATGAAGGACGGCAAATGGGAGCG |
| | GAAGAAGTTCATGGGAACAGAGCTGAATGGAAAGACCCTGGGAATT |
| | CTTGGCCTGGGCAGGATTGGGAGAGAGGTAGCTACCCGGATGCAGTC |
| | CTTTGGGATGAAGACTATAGGGTATGACCCCATCATTTCCTCTAGA |
| | (SEQ ID NO: 28) |
| pBLVRAref | GCATGCTAATACGACTCACTATAGGAACTGTGGGAGCTGGCTGAGCA |
| | GAAAGGAAAAGTCTTGCACGAGGAGCATGTTGAACTCTTGATGGAG |
| | GAATTCGCTTTCCTGAAAAAAGAAGTGGTGGGGAAAGACCTGCTGAA |
| | AGGGTCGCTCCTCTTCACAGCTGGCCCGTTGGAAGAAGAGCGGTTTG |
| | GCTTCCCTGCATTCAGCGGCATCTCTCGCCTGACCTGGCTGGTCTCCC |
| | TCTTTGGGGAGCTTTCTCTTGTGTCTGCCACTTTGGAATCTAGA |
| | (SEQ ID NO: 29) |
| pMDM2ref | GCATGCTAATACGACTCACTATAGGCGTCGTGCTTCCGCGCGCCCCG |
| | TGAAGGAAACTGGGGAGTCTTGAGGGACCCCCGACTCCAAGCGCGA |
| | AAACCCCGGATGGTGAGGAGCAGGCAAATGTGCAATACCAACATGT |
| | CTGTACCTACTGATGGTGCTGTAACCACCTCACAGATTCCAGCTTCGG |
| | AACAAGAGACCCTGGTTAGACCAAAGCCATTGCTTTTGAAGTTATTA |
| | AAGTCTGTTGGTGCACAAAAAGACACTTATACTATGAAATCTAGA |
| | (SEQ ID NO: 30) |
| pKIF2Cref | GCATGCTAATACGACTCACTATAGGACTTAACAAAGTATCTGGAGAA |
| | CCAAGCATTCTGCTTTGACTTTGCATTTGATGAAACAGCTTCGAATGA |
| | AGTTGTCTACAGGTTCACAGCAAGGCCACTGGTACAGACAATCTTTG |
| | AAGGTGGAAAAGCAACTTGTTTTGCATATGGCCAGACAGGAAGTGGC |
| | AAGACACATACTATGGGCGGAGACCTCTCTGGGAAAGCCCAGAATG |
| | CATCCAAAGGGATCTATGCCATGGCCTCCCGGGACGTCTCTAGA |
| | (SEQ ID NO: 31) |
| pESR1ref | GCATGCTAATACGACTCACTATAGATGATTGGTCTCGTCTGGCGCTCC |
| | ATGGAGCACCCAGGGAAGCTACTGTTTGCTCCTAACTTGCTCTTGGA |
| | CAGGAACCAGGGAAAATGTGTAGAGGGCATGGTGGAGATCTTCGAC |
| | ATGCTGCTGGCTACATCATCTCGGTTCCGCATGATGAATCTGCAGGG |
| | AGAGGAGTTTGTGTGCCTCAAATCTATTATTTTGCTTAATTCTGGAGT |
| | GTACACATTTCTGTCCAGCACCCTGAAGTCTCTGGAATCTAGA |
| | (SEQ ID NO: 32) |
| pKNTC2ref | GCATGCTAATACGACTCACTATAGAAGGCCCCGCTGTCCTGTCTAGC |
| | AGATACTTGCACGGTTTACAGAAATTCGGTCCCTGGGTCGTGTCAGG |
| | AAACTGGAAAAAAGGTCATAAGCATGAAGCGCAGTTCAGTTTCCAGC |
| | GGTGGTGCTGGCCGCCTCTCCATGCAGGAGTTAAGATCCCAGGATGT |
| | AAATAAACAAGGCCTCTATACCCCTCAAACCAAAGAGAAACCAACCT |
| | TTGGAAAGTTGAGTATAAACAAACCGACATCTGAAAGATCTAGA |
| | (SEQ ID NO: 33) |
| pEXO1ref | GCATGCTAATACGACTCACTATAGGGAAAGCAACTTCTTCGTGAGGG |
| | GAAAGTCTCGGAAGCTCGAGAGTGTTTCACCCGGTCTATCAATATCA |
| | CACATGCCATGGCCCACAAAGTAATTAAAGCTGCCCGGTCTCAGGGG |
| | GTAGATTGCCTCGTGGCTCCCTATGAAGCTGATGCGCAGTTGGCCTAT |
| | CTTAACAAAGCGGGAATTGTGCAAGCCATAATTACAGAGGACTCGGA |
| | TCTCCTAGCTTTTGGCTGTAAAAAGGTAATTTTAAAGTCTAGA |
| | (SEQ ID NO: 34) |
| pCCNB1ref | GCATGCTAATACGACTCACTATAGATGTGGATGCAGAAGATGGAGCT |
| | GATCCAAACCTTTGTAGTGAATATGTGAAAGATATTTATGCTTATCTG |
| | AGACAACTTGAGGAAGAGCAAGCAGTCAGACCAAAATACCTACTGG |
| | GTCGGGAAGTCACTGGAAACATGAGAGCCATCCTAATTGACTGGCTA |
| | GTACAGGTTCAAATGAAATTCAGGTTGTTGCAGGAGACCATGTACAT |
| | GACTGTCTCCATTATTGATCGGTTCATGCAGAATAATTTCTAGA |
| | (SEQ ID NO: 35) |
| pCDH3ref | GCATGCTAATACGACTCACTATAGATCAGCTACCGCATCCTGAGAGA |
| | CCCAGCAGGGTGGCTAGCCATGGACCCAGACAGTGGGCAGGTCACA |
| | GCTGTGGGCACCCTCGACCGTGAGGATGAGCAGTTTGTGAGGAACAA |
| | CATCTATGAAGTCATGGTCTTGGCCATGGACAATGGAAGCCCTCCCA |
| | CCACTGGCACGGGAACCCTTCTGCTAACACTGATTGATGTCAATGAC |
| | CATGGCCCAGTCCCTGAGCCCCGTCAGATCACCATCTGCTCTAGA |
| | (SEQ ID NO: 36) |
| pCCNE1ref | GCATGCTAATACGACTCACTATAGGTATACTTGCTGCTTCGGCCTTGT |
| | ATCATTTCTCGTCATCTGAATTGATGCAAAAGGTTTCAGGGTATCAGT |
| | GGTGCGACATAGAGAACTGTGTCAAGTGGATGGTTCCATTTGCCATG |
| | GTTATAAGGGAGACGGGGAGCTCAAAACTGAAGCACTTCAGGGGCG |
| | TCGCTGATGAAGATGCACACAACATACAGACCCACAGAGACAGCTTG |
| | GATTTGCTGGACAAAGCCCGAGCAAAGAAAGCCATGTTCTAGA |
| | (SEQ ID NO: 37) |
| pKRT17ref | GCATGCTAATACGACTCACTATAGAATACAAAATCCTGCTGGATGTG |
| | AAGACGCGGCTGGAGCAGGAGATTGCCACCTACCGCCGCCTGCTGGA |
| | GGGAGAGGATGCCCACCTGACTCAGTACAAGAAAGAACCGGTGACC |
| | ACCCGTCAGGTGCGTACCATTGTGGAAGAGGTCCAGGATGGCAAGGT |
| | CATCTCCTCCCGCGAGCAGGTCCACCAGACCACCCGCTGAGGACTCA |
| | GCTACCCCGGCCGGCCACCCAGGAGGCAGGGAGCAGCCGTCTAGA |
| | (SEQ ID NO: 38) |
| pCDCA1ref | GCATGCTAATACGACTCACTATAGAGAGGACGGAGGAAGGAAGCCT |
| | GCAGACAGACGCCTTCTCCATCCCAAGGCGCGGGCAGGTGCCGGGAC |
| | GCTGGGCCTGGCGGTGTTTTCGTCGTGCTCAGCGGTGGGAGGAGGCG |
| | GAAGAAACCAGAGCCTGGGAGATTAACAGGAAACTTCCAAGATGGA |
| | AACTTTGTCTTTCCCCAGATATAATGTAGCTGAGATTGTGATTCATAT |
| | TCGCAATAAGATCTTAACAGGAGCTGATGGTAAAAACCTTCTAGA |
| | (SEQ ID NO: 39) |
| pCXXC5ref | GCATGCTAATACGACTCACTATAGAAGCCTTCCGCTGCTCTGGAGAA |
| | GGTGATGCTTCCGACGGGAGCCGCCTTCCGGTGGTTTCAGTGACGGC |
| | GGCGGAACCCAAAGCTGCCCTCTCCGTGCAATGTCACTGCTCGTGTG |
| | GTCTCCAGCAAGGGATTCGGGCGAAGACAAACGGATGCACCCGTCTT |
| | TAGAACCAAAAATATTCTCTCACAGATTTCATTCCTGTTTTTATATAT |
| | ATATTTTTTGTTGTCGTTTTAACATCTCCACGTCCCTTCTAGA |
| | (SEQ ID NO: 40) |
| pORC6Lref | GCATGCTAATACGACTCACTATAGATTCTAAAGCTGAAAGTGGATAA |
| | AAACAAAATGGTAGCCACATCCGGTGTAAAAAAAGCTATATTTGATC |
| | GACTGTGTAAACAACTAGAGAAGATTGGACAGCAGGTCGACAGAGA |
| | ACCTGGAGATGTAGCTACTCCACCACGGAAGAGAAAGAAGATAGTG |
| | GTTGAAGCCCCAGCAAAGGAAATGGAGAAGGTAGAGGAGATGCCAC |
| | ATAAACCACAGAAAGATGAAGATCTGACACAGGATTATGAATCTAG |
| | A (SEQ ID NO: 41) |
| pACTR3Bref | GCATGCTAATACGACTCACTATAGATATAGTCAAGGAATTTGCCAAG |
| | TATGATGTGGATCCCCGGAAGTGGATCAAACAGTACACGGGTATCAA |
| | TGCGATCAACCAGAAGAAGTTTGTTATAGACGTTGGTTACGAAAGAT |
| | TCCTGGGACCTGAAATATTCTTTCACCCGGAGTTTGCCAACCCAGACT |
| | TTATGGAGTCCATCTCAGATGTTGTTGATGAAGTAATACAGAACTGC |
| | CCCATCGATGTGCGGCGCCCGCTGTATAAGCCCGAGTTCTAGA |
| | (SEQ ID NO: 42) |
| pUBE2Cref | GCATGCTAATACGACTCACTATAGAAGTTCCTCACGCCCTGCTATCAC |
| | CCCAACGTGGACACCCAGGGTAACATATGCCTGGACATCCTGAAGGA |
| | AAAGTGGTCTGCCCTGTATGATGTCAGGACCATTCTGCTCTCCATCCA |
| | GAGCCTTCTAGGAGAACCCAACATTGATAGTCCCTTGAACACACATG |
| | CTGCCGAGCTCTGGAAAAACCCCACAGCTTTTAAGAAGTACCTGCAA |
| | GAAACCTACTCAAAGCAGGTCACCAGCCAGGAGCCCTCTAGA |
| | (SEQ ID NO: 43) |
| pNAT1ref | GCATGCTAATACGACTCACTATAGAGCACTTCCTCATAGACCTTGGA |
| | TGTGGGAGGATTGCATTCAGTCTAGTTCCTGGTTGCCGGCTGAAATA |
| | ACCTGAATTCAAGCCAGGAAGAAGCAGCAATCTGTCTTCTGGATTAA |
| | AACTGAAGATCAACCTACTTTCAACTTACTAAGAAAGGGGATCATGG |
| | ACATTGAAGCATATCTTGAAAGAATTGGCTATAAGAAGTCTAGGAAC |
| | AAATTGGACTTGGAAACATTAACTGACATTCTTCAACATCTAGA |
| | (SEQ ID NO: 44) |
| pPTTG1ref | GCATGCTAATACGACTCACTATAGGGGTCTGGACCTTCAATCAAAGC |
| | CTTAGATGGGAGATCTCAAGTTTCAACACCACGTTTTGGCAAAACGT |
| | TCGATGCCCCACCAGCCTTACCTAAAGCTACTAGAAAGGCTTTGGGA |
| | ACTGTCAACAGAGCTACAGAAAAGTCTGTAAAGACCAAGGGACCCC |
| | TCAAACAAAAACAGCCAAGCTTTTCTGCCAAAAAGATGACTGAGAA |
| | GACTGTTAAAGCAAAAAGCTCTGTTCCTGCCTCAGATGATTCTAGA |
| | (SEQ ID NO: 45) |
| pMMP11ref | GCATGCTAATACGACTCACTATAGGATGACCAGGGCACAGACCTGCT |
| | GCAGGTGGCAGCCCATGAATTTGGCCACGTGCTGGGGCTGCAGCACA |
| | CAACAGCAGCCAAGGCCCTGATGTCCGCCTTCTACACCTTTCGCTACC |
| | CACTGAGTCTCAGCCCAGATGACTGCAGGGGCGTTCAACACCTATAT |
| | GGCCAGCCCTGGCCCACTGTCACCTCCAGGACCCCAGCCCTGGGCCC |
| | CCAGGCTGGGATAGACACCAATGAGATTGCACCGCTGTCTAGA |
| | (SEQ ID NO: 46) |
| pFGFR4ref | GCATGCTAATACGACTCACTATAGGCTCCCGGCCAACACCACAGCCG |
| | TGGTGGGCAGCGACGTGGAGCTGCTGTGCAAGGTGTACAGCGATGCC |
| | CAGCCCCACATCCAGTGGCTGAAGCACATCGTCATCAACGGCAGCAG |
| | CTTCGGAGCCGACGGTTTCCCCTATGTGCAAGTCCTAAAGACTGCAG |
| | ACATCAATAGCTCAGAGGTGGAGGTCCTGTACCTGCGGAACGTGTCA |
| | GCCGAGGACGCAGGCGAGTACACCTGCCTCGCAGGCAATCTAGA |
| | (SEQ ID NO: 47) |
| pERBB2ref | GCATGCTAATACGACTCACTATAGGTGGAGCCGCTGACACCTAGCGG |
| | AGCGATGCCCAACCAGGCGCAGATGCGGATCCTGAAAGAGACGGAG |
| | CTGAGGAAGGTGAAGGTGCTTGGATCTGGCGCTTTTGGCACAGTCTA |
| | CAAGGGCATCTGGATCCCTGATGGGGAGAATGTGAAAATTCCAGTGG |
| | CCATCAAAGTGTTGAGGGAAAACACATCCCCCAAAGCCAACAAAGA |
| | AATCTTAGACGAAGCATACGTGATGGCTGGTGTGGGCTCCTCTAGA |
| | (SEQ ID NO: 48) |
| pMAPTref | GCATGCTAATACGACTCACTATAGAGAGGACACAAAAGAGGCTGAC |
| | CTTCCAGAGCCCTCTGAAAAGCAGCCTGCTGCTGCTCCGCGGGGGAA |
| | GCCCGTCAGCCGGGTCCCTCAACTCAAAGCTCGCATGGTCAGTAAAA |
| | GCAAAGACGGGACTGGAAGCGATGACAAAAAAGCCAAGACATCCAC |
| | ACGTTCCTCTGCTAAAACCTTGAAAAATAGGCCTTGCCTTAGCCCCA |
| | AACACCCCACTCCTGGTAGCTCAGACCCTCTGATCCAACCTCTAGA |
| | (SEQ ID NO: 49) |
| pTMEM45Bref | GCATGCTAATACGACTCACTATAGGAACACCCGAATGGGACCAGAA |
| | GGATGATGCCAACCTCATGTTCATCACCATGTGCTTCTGCTGGCACTA |
| | CCTGGCTGCCCTCAGCATTGTGGCCGTCAACTATTCTCTTGTTTACTG |
| | CCTTTTGACTCGGATGAAGAGACACGGAAGGGGAGAAATCATTGGA |
| | ATTCAGAAGCTGAATTCAGATGACACTTACCAGACCGCCCTCTTGAG |
| | TGGCTCAGATGAGGAATGAGCCGAGATGCGGAGGGCGCTCTAGA |
| | (SEQ ID NO: 50) |
| pTFRCref | GCATGCTAATACGACTCACTATAGAACTTTCATTCTTTGGACATGCTC |
| | ATCTGGGGACAGGTGACCCTTACACACCTGGATTCCCTTCCTTCAATC |
| | ACACTCAGTTTCCACCATCTCGGTCATCAGGATTGCCTAATATACCTG |
| | TCCAGACAATCTCCAGAGCTGCTGCAGAAAAGCTGTTTGGGAATATG |
| | GAAGGAGACTGTCCCTCTGACTGGAAAACAGACTCTACATGTAGGAT |
| | GGTAACCTCAGAAAGCAAGAATGTGAAGCTCACTGTCTAGA |
| | (SEQ ID NO: 51) |
| pGUSBref | GCATGCTAATACGACTCACTATAGGCGCTGCCGCAGTTCTTCAACAA |
| | CGTTTCTCTGCATCACCACATGCAGGTGATGGAAGAAGTGGTGCGTA |
| | GGGACAAGAACCACCCCGCGGTCGTGATGTGGTCTGTGGCCAACGAG |
| | CCTGCGTCCCACCTAGAATCTGCTGGCTACTACTTGAAGATGGTGATC |
| | GCTCACACCAAATCCTTGGACCCCTCCCGGCCTGTGACCTTTGTGAGC |
| | AACTCTAACTATGCAGCAGACAAGGGGGCTCCGTATTCTAGA |
| | (SEQ ID NO: 52) |
| pMRPL19ref | GCATGCTAATACGACTCACTATAGAAAAGATATGTTAGAAAGGAGA |
| | AAAGTACTCCACATTCCAGAGTTCTATGTTGGAAGTATTCTTCGTGTT |
| | ACTACAGCTGACCCATATGCCAGTGGAAAAATCAGCCAGTTTCTGGG |
| | GATTTGCATTCAGAGATCAGGAAGAGGACTTGGAGCTACTTTCATCC |
| | TTAGGAATGTTATCGAAGGACAAGGTGTCGAGATTTGCTTTGAACTT |
| | TATAATCCTCGGGTCCAGGAGATTCAGGTGGTCAAATTTCTAGA |
| | (SEQ ID NO: 53) |
| pSF3A1ref | GCATGCTAATACGACTCACTATAGAACACATGCGCATTGGACTTCTT |
| | GACCCTCGCTGGCTGGAGCAGCGGGATCGCTCCATCCGTGAGAAGCA |
| | GAGCGATGATGAGGTGTACGCACCAGGTCTGGATATTGAGAGCAGCT |
| | TGAAGCAGTTGGCTGAGCGGCGTACTGACATCTTCGGTGTAGAGGAA |
| | ACAGCCATTGGTAAGAAGATCGGTGAGGAGGAGATCCAGAAGCCAG |
| | AGGAAAAGGTGACCTGGGATGGCCACTCAGGCAGCATGGTCTAGA |
| | (SEQ ID NO: 54) |
| pPSMC4ref | GCATGCTAATACGACTCACTATAGAGCAAAAGAACCTGAAAAAGGA |
| | ATTTCTCCATGCCCAGGAGGAGGTGAAGCGAATCCAAAGCATCCCGC |
| | TGGTCATCGGACAATTTCTGGAGGCTGTGGATCAGAATACAGCCATC |
| | GTGGGCTCTACCACAGGCTCCAACTATTATGTGCGCATCCTGAGCAC |
| | CATCGATCGGGAGCTGCTCAAGCCCAACGCCTCAGTGGCCCTCCACA |
| | AGCACAGCAATGCACTGGTGGACGTGCTGCCCCCCGAAGTCTAGA |
| | (SEQ ID NO: 55) |
| pRPLP0ref | GCATGCTAATACGACTCACTATAGATGCCCAGGGAAGACAGGGCGA |
| | CCTGGAAGTCCAACTACTTCCTTAAGATCATCCAACTATTGGATGATT |
| | ATCCGAAATGTTTCATTGTGGGAGCAGACAATGTGGGCTCCAAGCAG |
| | ATGCAGCAGATCCGCATGTCCCTTCGCGGGAAGGCTGTGGTGCTGAT |
| | GGGCAAGAACACCATGATGCGCAAGGCCATCCGAGGGCACCTGGAA |
| | AACAACCCAGCTCTGGAGAAACTGCTGCCTCATATCCGGTCTAGA |
| | (SEQ ID NO: 56) |
| pPUM1ref | GCATGCTAATACGACTCACTATAGGTAAAAAGTTTTGGGAAACAGAT |
| | GAATCCAGCAAAGATGGACCAAAAGGAATATTCCTGGGTGATCAAT |
| | GGCGAGACAGTGCCTGGGGAACATCAGATCATTCAGTTTCCCAGCCA |
| | ATCATGGTGCAGAGAAGACCTGGTCAGAGTTTCCATGTGAACAGTGA |
| | GGTCAATTCTGTACTGTCCCCACGATCGGAGAGTGGGGGACTAGGCG |
| | TTAGCATGGTGGAGTATGTGTTGAGCTCATCCCCGGGCGTCTAGA |
| | (SEQ ID NO: 57) |
| pACTBref | GCATGCTAATACGACTCACTATAGGTCCACACAGGGGAGGTGATAGC |
| | ATTGCTTTCGTGTAAATTATGTAATGCAAAATTTTTTTAATCTTCGCCT |
| | TAATACTTTTTTATTTTGTTTTATTTTGAATGATGAGCCTTCGTGCCCC |
| | CCCTTCCCCCTTTTTGTCCCCCAACTTGAGATGTATGAAGGCTTTTGG |
| | TCTCCCTGGGAGTGGGTGGAGGCAGCCAGGGCTTACCTGTACACTGA |
| | CTTGAGACCAGTTGAATAAAAGTGCACACCTTATCTAGA |
| | (SEQ ID NO: 58) |

Plasmid Transformation and Purification

Each purified plasmid described above can be directly used in a PCR amplification reaction (see below). If more plasmid template is desirable, each plasmid can be transformed into E. coli and subsequently purified using standard molecular biology protocols. The concentration of each plasmid is measured on a spectrophotometer following purification.

PCR Amplification of Purified Plasmids

Each Plasmid (50 ng/μL diluted in 10 mM Tris pH 8) is amplified in a separate PCR reaction containing the following components:

TABLE 2
Standard PCR reaction for all targets:

| Reagent | Volume per 50-μL rxn (μL) |
|---|---|
| Plasmid template (50 ng/μl) | 1.0 |
| 10 μM reverse primer | 1.0 |
| 10 μM Forward primer- T7 | 1.0 |
| DEPC H₂O | 35.0 |
| 10x Taq KCl buffer | 5.0 |
| 25 mM MgCl₂ | 5.0 |
| 10 mM dNTPs | 1.0 |
| Taq DNA polymerase | 1.0 |

A common forward primer (T7) and gene specific reverse primers were selected to amplify the 279 base-pair insert for each nucleic acid target.

TABLE 3
Primer sequences used for PCR amplification

| | | SEQ ID |
|---|---|---|
| Primer Name | Sequence (5′-3′) | NO: |
| 5′ T7 | GCA TGC TAA TAC GAC TCA CTA TAG | 59 |
| 3′ FOXA1ref | TAG GTG TTC ATG GAG TTC ATG G | 60 |
| 3′ KRT5ref | CAC CAC CAC CGC CAC CCC | 61 |
| 3′ BCL2ref | TGC AAG TGA ATG AAC ACC TTC TC | 62 |
| 3′ BIRC5ref | AGG ATT TAG GCC ACT GCC TTT | 63 |
| 3′ GPR160ref | CCC AAC AGG TTA TGA AAG CTA C | 64 |
| 3′ CEP55ref | AGT CTG TGA TAA ACG GAG TGT ATT G | 65 |
| 3′ TYMSref | CTG ATT CCA TAT CTC TGT ATT CTG CC | 66 |
| 3′ SLC39A6ref | CGT GGA AAT GTG AAT GGC ATT TAT TC | 67 |
| 3′ SFRP1ref | TCT AAA TGG CCC TTG CTT TAC CCG | 68 |
| 3′ MLPHref | AAA AGA ATC ATC ATC TTT ACC TTG AC | 69 |
| 3′ CENPFref | TCT CTG GGG CTG TCA GTC | 70 |
| 3′ KRT14ref | TGG GAT CTG TGT CCA CAC | 71 |
| 3′ RRM2ref | CTT CTG TAA TCT GAA CTT CTT GGC | 72 |
| 3′ FOXC1ref | TAC AGT CGT AGA CGA AAG CTC | 73 |
| 3′ CDC20ref | ACT GGC CAA ATG TCG TCC ATC | 74 |
| 3′ PGRref | TGA CAG CAC TTT CTA AGG CG | 75 |
| 3′ GRB7ref | TTC GAA GCT TGT TGG GCT TG | 76 |
| 3′ ANLNref | GTT TTT TTG ATG GCG ATG GTT T | 77 |
| 3′ EGFRref | GGG TAT AGA TTC TGT GTA AAA TTG ATT CC | 78 |
| 3′ MKI67ref | TTT TGC AAC AAT CAG ATT TGC TTC | 79 |
| 3′ BAG1ref | ACC CGG CAA CCA TCT TGT ATT CCA | 80 |
| 3′ UBE2Tref | AAG GTG TGT TGG CTC CAC CTA | 81 |
| 3′ MYBL2ref | TCC TCG AGC TCC AGC AGC AAG TAC AC | 82 |
| 3′ MELKref | GGT CCC TGT GAG CAT AGC | 83 |
| 3′ MYCref | TTG GAC GGA CAG GAT GTA TGC | 84 |
| 3′ CDC6ref | CTT CAA TCT TGA AAA ACA CCT TAA ACG GG | 85 |
| 3′ MIAref | CTT CAC ATC GAC TTT GCC AG | 86 |
| 3′ PHGDHref | GGA AAT GAT GGG GTC ATA CCC TAT | 87 |
| 3′ BLVRAref | TTC CAA AGT GGC AGA CAC AAG A | 88 |
| 3′ MDM2ref | TTT CAT AGT ATA AGT GTC TTT TTG TGC | 89 |
| 3′ KIF2Cref | GAC GTC CCG GGA GGC CAT | 90 |
| 3′ ESR1ref | TTC CAG AGA CTT CAG GGT G | 91 |
| 3′ KNTC2ref | TCT TTC AGA TGT CGG TTT GTT TAT AC | 92 |
| 3′ EXO1ref | CTT TAA AAT TAC CTT TTT ACA GCC AAA AG | 93 |
| 3′ CCNB1ref | AAT TAT TCT GCA TGA ACC GAT CAA TAA TG | 94 |
| 3′ CDH3ref | GCA GAT GGT GAT CTG ACG G | 95 |
| 3′ CCNE1ref | ACA TGG CTT TCT TTG CTC G | 96 |
| 3′ KRT17ref | CGG CTG CTC CCT GCC TCC | 97 |
| 3′ CDCA1ref | AGG TTT TTA CCA TCA GCT CCT G | 98 |
| 3′ CXXC5ref | AGG GAC GTG GAG ATG TTA AAA C | 99 |
| 3′ ORC6Lref | TTC ATA ATC CTG TGT CAG ATC TTC | 100 |
| 3′ ACTR3Bref | ACT CGG GCT TAT ACA GCG G | 101 |
| 3′ UBE2Cref | GGG CTC CTG GCT GGT GAC | 102 |
| 3′ NAT1ref | TGT TGA AGA ATG TCA GTT AAT GTT TC | 103 |
| 3′ PTTG1ref | ATC ATC TGA GGC AGG AAC AGA | 104 |
| 3′ MMP11ref | CAG CGG TGC AAT CTC ATT G | 105 |
| 3′ FGFR4ref | TTG CCT GCG AGG CAG GTG | 106 |
| 3′ ERBB2ref | GGA GCC CAC ACC AGC CAT C | 107 |
| 3′ MAPTref | GGT TGG ATC AGA GGG TCT G | 108 |
| 3′ TMEM45Bref | GCG CCC TCC GCA TCT CGG | 109 |
| 3′ TFRCref | CAG TGA GCT TCA CAT TCT TGC | 110 |
| 3′ GUSBref | ATA CGG AGC CCC CTT GTC | 111 |
| 3′ MRPL19ref | AAT TTG ACC ACC TGA ATC TCC | 112 |
| 3′ SF3A1ref | CCA TGC TGC CTG ACT GGC | 113 |
| 3′ PSMC4ref | CTT CGG GGG GCA GCA CGT C | 114 |
| 3′ RPLP0ref | CCG GAT ATG AGG CAG CAG TTT C | 115 |
| 3′ PUM1ref | CGC CCG GGG ATG AGC TCA AC | 116 |
| 3′ ACTBref | TAA GGT GTG CAC TTT TAT TCA ACT G | 117 |

The standard scale is a 50-μL reaction volume. The reactions can be scaled up or down, provided the ratios in Table 2 are scaled accordingly. Except for SFRP1, each plasmid is amplified on a standard thermocycler using the following program:
Initial denature: 94° C. for 3 minutes
30×cycles: Denature: 94° C. for 30 seconds
   Anneal: 55° C. for 30 seconds
   Extension: 72° C. for 30 seconds
Final extension: 72° C. for 15 minutes
4° C. hold

For SFRP1, run reactions on a thermocycler using the following program:
Initial denature: 94° C. for 3 minutes
30×cycles: Denature: 94° C. for 30 seconds
   Anneal: 65° C. for 30 seconds
Extension: 72° C. for 30 seconds
Final extension: 72° C. for 15 minutes
4° C. hold

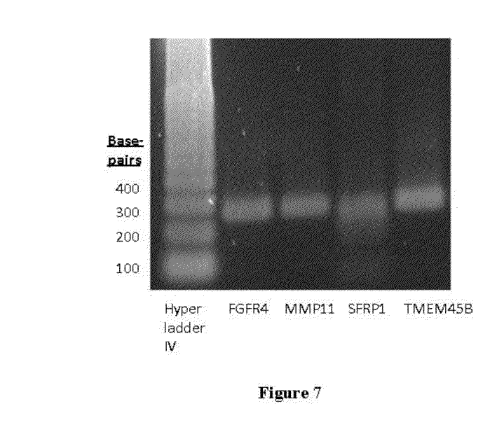

The full length amplicons are purified using a Qiagen QIAquick PCR Purification kit and eluted in 30 μL of Elution Buffer supplied with the kit. The concentration of the purified PCR products is determined using the Nanodrop spectrophotometer in “dsDNA” mode. The resulting PCR products are analyzed using a 1.8% agarose gel stained with SYBR gold where the PCR amplicons are compared against Hyperladder IV as a reference. The major band of the resulting PCR amplicons runs close to the 300 bp marker as expected, as shown in FIG. 7 for a few representative PCR products.

Preparation of In-Vitro Transcribed RNA Products

In-vitro transcribed (IVT) RNA products for each of the 58 nucleic acid targets are prepared from the corresponding PCR amplicons using the MEGAShortscript T7 kit manufactured by Ambion.

TABLE 4
IVT reaction set-up for 1 20-μL reaction

| | Volume required |
|---|---|
| Reagent | per 20-μL rxn |
| PCR target template | 8 μL (120-1000 ng) |
| 75 mM ATP | 2 μL |
| 75 mM CTP | 2 μL |
| 75 mM UTP | 2 μL |
| 75 mM GTP | 2 μL |
| 10X T7 buffer | 2 μL |
| T7 Enzyme Mix | 2 μL |

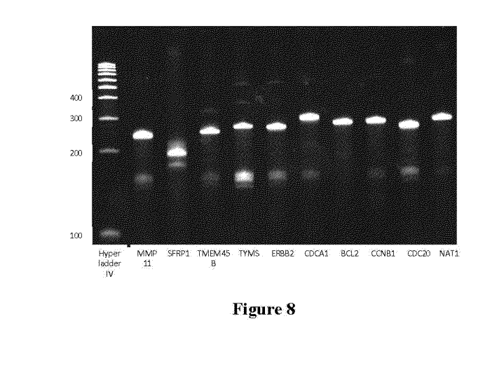

Each IVT reaction is incubated at 37° C. for 16-20 hours in a thermocycler with heated lid on. Following the 16-20 hour incubation, residual DNA from the IVT reaction is digested by adding 1 μL of Turbo DNase solution from the MEGAShortScript kit to each 20-μL IVT reaction and incubating at 37° C. for 30 minutes. The IVT products are purified using a Qiagen RNeasy mini column and eluted in Tris/EDTA buffer (pH 7). Following heat denaturation, the purified RNA transcripts are analyzed on a denaturing gel where the major band is typically located at approximately 250-300 bases in length with the exception of SFRP1 which is located at 200 bases in length (see FIG. 8). The concentration of each IVT RNA product is measured using a UV-visible spectrophotometer at 260 nm wavelength.

Mixing of IVT RNA Products to Create the Reference Sample

In this example, the reference sample consists of an equimolar ratio of all 58 IVT RNA products representing the nucleic acid targets of interest. The IVT RNAs are mixed based on the measured concentration of each RNA and then diluted in TE buffer to a final concentration of 120 fM each transcript for use with the NanoString nCounter® Analysis System. The performance of the reference sample is measured using the NanoString nCounter® Analysis System and a CodeSet designed specifically to those genes as described in Example 2.

### Example 2

### Use of the Reference Sample for a Multivariate Gene Assay Designed to Detect Intrinsic Breast Cancer Subtypes

The multivariate gene assay described in this example identifies the intrinsic subtype of a formalin-fixed paraffin embedded breast tumor sample using a 50-gene classifier algorithm which analyzes the expression levels of the genes. This 50-gene classifier algorithm is described in greater detail in International Publication No. WO 09/158143 and U.S. Patent Publication No. 2011/0145176, incorporated herein by reference in its entirety. The test simultaneously measures the expression levels of the 50 genes used for the classification algorithm (50 target genes) and an additional 8 housekeeping genes (ACTB, MRPL19, PSMC4, PUM1, RPLP1, SF3A1, GUSB, TFRC) as shown in Table 5.

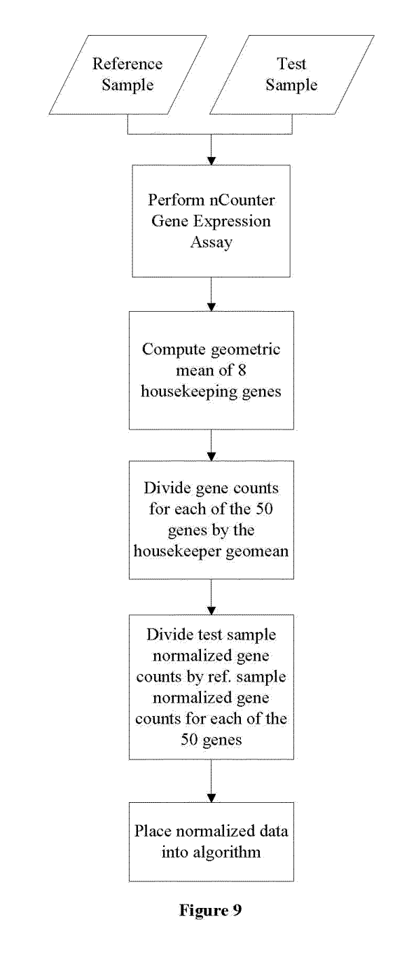

The 58 genes are measured in a single hybridization reaction using an nCounter® gene expression CodeSet designed specifically to those genes following documented procedures for gene expression analysis (www.nanostring.com), FIG. 9. The CodeSet includes nanoreporters constructed to specifically hybridize with each of the 58 genes, along with a set of capture probes. In addition to the 58 gene targets, the CodeSet also includes spiked RNA targets and corresponding nanoreporters as positive assay controls and a set of negative assay controls that consist of nanoreporters without targets.

TABLE 5

| Gene | Accession |
|---|---|
| UBE2T | NM_014176.1 |
| PTTG1 | NM_004219.2 |
| PGR | NM_000926.2 |
| MKI67 | NM_002417.2 |
| MIA | NM_006533.1 |
| MAPT | NM_016835.3 |
| KRT17 | NM_000422.1 |
| KRT14 | NM_000526.3 |
| KIF2C | NM_006845.2 |
| ESR1 | NM_000125.2 |
| CCNE1 | NM_001238.1 |
| CENPF | NM_016343.3 |
| CEP55 | NM_018131.3 |
| FGFR4 | NM_002011.3 |
| MMP11 | NM_005940.3 |
| SFRP1 | NM_003012.3 |
| TMEM45B | NM_138788.3 |
| TYMS | NM_001071.1 |
| ERBB2 | NM_004448.2 |
| CDCA1 | NM_145697.1 |
| BCL2 | NM_000633.2 |
| CCNB1 | NM_031966.2 |
| CDC20 | NM_001255.1 |
| NAT1 | NM_000662.4 |
| ORC6L | NM_014321.2 |
| RRM2 | NM_001034.1 |
| UBE2C | NM_007019.2 |
| ACTR3B | NM_001040135.1 |
| ANLN | NM_018685.2 |
| BAG1 | NM_004323.3 |
| BIRC5 | NM_001168.2 |
| BLVRA | NM_000712.3 |
| CDC6 | NM_001254.3 |
| CDH3 | NM_001793.3 |
| CXXC5 | NM_016463.5 |
| EGFR | NM_005228.3 |
| EXO1 | NM_006027.3 |
| FOXA1 | NM_004496.2 |
| FOXC1 | NM_001453.1 |
| GPR160 | NM_014373.1 |
| GRB7 | NM_005310.2 |
| KNTC2 | NM_006101.1 |
| KRT5 | NM_000424.2 |
| MDM2 | NM_006878.2 |
| MELK | NM_014791.2 |
| MLPH | NM_024101.4 |
| MYBL2 | NM_002466.2 |
| MYC | NM_002467.3 |
| PHGDH | NM_006623.2 |
| SLC39A6 | NM_012319.2 |
| TFRC | NM_003234.1 |
| ACTB | NM_001101.2 |
| MRPL19 | NM_014763.3 |
| PSMC4 | NM_006503.2 |
| PUM1 | NM_001020658.1 |
| RPLP0 | NM_001002.3 |
| SF3A1 | NM_005877.4 |
| GUSB | NM_000181.1 |

Formalin-fixed paraffin embedded (FFPE) breast tumor samples were used in this example. A certified pathologist circled the area of invasive breast carcinoma on each FFPE block, and 2×1 mm diameter core tissue punches were taken from within the designated area, or alternatively, slide mounted tissue sections were cut from the block. RNA was isolated from each FFPE breast tumor sample using an RNA isolation kit supplied by Roche diagnostics with slight procedural modifications to the provided package insert, including a longer proteinase K digest time to dissolve the tissue and a lower elution volume of 30 uL. The amount of RNA isolated from each tumor test sample was quantified using a Nanodrop spectrophotometer.

The 58 genes of interest are then analyzed in each tumor RNA sample using the described CodeSet on the nCounter® analysis system. In this assay, 250 ng of RNA isolated from each breast tumor tissue test sample is tested alongside 2 reference sample controls. For each set of up to 10 RNA samples, the user pipets 250 ng of RNA into separate tubes within a 12 reaction strip tube and adds the CodeSet and hybridization buffer. The user pipets reference sample into the remaining two tubes with CodeSet and hybridization buffer. Following the nCounter® assay process, the 50 nucleic acid target genes from both the reference sample and test sample are housekeeper normalized, FIG. 9. The expression levels of the 50 nucleic acid target genes from the test sample are subsequently normalized to the expression level of the corresponding nucleic acid target genes within the reference sample. The normalized data is then input into the algorithm to determine the intrinsic subtype, risk of relapse score, and proliferation score based on a proliferation gene subset within the 50 genes.

What is claimed is:

1. A composition for the multiplexed detection of a plurality of target nucleic acid molecules from a biological sample comprising:
a plurality of probe molecules, wherein each probe molecule in the plurality specifically binds to one target nucleic acid molecule in the sample, and wherein the plurality of probe molecules are capable of non-enzymatic direct detection of the target nucleic acid molecules; and,
a plurality of reference molecules that represent each of the plurality of target nucleic acid molecules, wherein the probe molecules specifically bind to the plurality of reference molecules, and wherein each of the plurality of reference molecules is present in known amounts.

2. The composition of claim 1, wherein the plurality of reference molecules that represent each of the plurality of nucleic acid molecules comprise synthesized nucleic acids.

3. The composition of claim 2, wherein the plurality of synthesized reference molecules that represent each of the plurality of nucleic acid molecules comprise in vitro transcribed RNA.

4. The composition of claim 2, wherein the plurality of synthesized reference molecules that represent each of the plurality of nucleic acid molecules comprise chemically synthesized nucleic acids.

5. The composition of claim 1, wherein the reference molecules are used to correct for variations in efficiency of an individual assay.

6. The composition of claim 1, wherein the plurality of probe molecules comprises about 8 to about 50 probe molecules.

7. The composition of claim 1, wherein the plurality of probe molecules comprises about 25 to about 50 probe molecules.

8. The composition of claim 1, wherein the plurality of probe molecules comprises about 50 to about 100 probe molecules.

9. The composition of claim 1, wherein the plurality of probe molecules comprises more than 100 probe molecules.

10. The composition of claim 1, wherein the probe molecules are nucleic acid probes.

11. The composition of claim 10, wherein each nucleic acid probe comprises
(i) a target-specific region that specifically binds to a target nucleic acid molecule; and
(ii) a region comprising a plurality of label-attachment regions linked together, wherein each label attachment region is attached to a plurality of label monomers that create a unique code for each target-specific probe, said code having a detectable signal that distinguishes one nucleic acid probe which binds to a first target nucleic acid from another nucleic acid probe that binds to a different second target nucleic acid molecule.

12. The composition of claim 11, wherein the plurality of label-attachment regions comprises at least four label attachment regions.

13. The composition of claim 11, wherein the plurality of label monomers comprises at least 4 label monomers.

14. The composition of claim 11, wherein each of said label monomers are selected from the group consisting of a fluorochrome moiety, a fluorescent moiety, a dye moiety and a chemiluminescent moiety.

15. The composition of claim 10, wherein the nucleic acid probe further comprises an affinity tag.

16. A kit comprising the composition of claim 1 and instructions for the multiplexed detection of a plurality of target nucleic acid molecules.

17. The kit of claim 16, further comprising an apparatus, wherein said apparatus comprises a surface capable of binding the hybridized probe molecules of said kit under suitable binding conditions.

18. The kit of claim 16, further comprising a composition for the extraction of the target nucleic acids from a biological sample.

19. The kit of claim 16, further comprising a reagent selected from the group consisting of a hybridization reagent, a purification reagent, an immobilization reagent and an imaging reagent.

20. A method of detecting the expression of a plurality of target nucleic acid molecules from a biological sample comprising:
providing a biological sample;
providing a plurality of probe molecules, wherein each probe molecule in the plurality specifically binds to one target nucleic acid molecule in the sample;
contacting the biological sample and the plurality of probe molecules under conditions; sufficient for hybridization of at least one probe molecule and one target nucleic acid molecule; and
detecting a signal associated with each of the plurality of probe molecules bound to each corresponding target nucleic acid molecule, wherein the detection is non-enzymatic.

21. The method of claim 20, further comprising
providing a plurality of reference molecules that represent each of the plurality of target nucleic acid molecules, wherein each of the plurality of reference molecules is present in known amounts;
detecting a signal associated with each of the plurality of probe molecules bound to each corresponding reference nucleic acid molecule; and
normalizing the signal associated with each of the plurality of probe molecules bound to each corresponding target nucleic acid molecule with the corresponding signal associated with each of the plurality of probe molecules bound to each corresponding reference nucleic acid molecule,
thereby quantifying the normalized expression of the plurality of target nucleic acid molecules.

22. The method of claim 21, wherein the plurality of reference molecules that represent each of the plurality of nucleic acid molecules comprise synthesized nucleic acids.

23. The method of claim 22, wherein the plurality of synthesized reference molecules that represent each of the plurality of nucleic acid molecules comprise in vitro transcribed RNA.

24. The method of claim 22 wherein the plurality of synthesized reference molecules that represent each of the plurality of nucleic acid molecules comprise chemically synthesized nucleic acids.

25. The method of claim 21, wherein the reference molecules are used to correct for variations in efficiency of an individual assay.

26. The method of claim 20, wherein the plurality of probe molecules comprises about 8 to about 50 probe molecules.

27. The method of claim 20, wherein the plurality of probe molecules comprises about 25 to about 50 probe molecules.

28. The method of claim 20, wherein the plurality of probe molecules comprises about 50 to about 100 probe molecules.

29. The method of claim 20, wherein the plurality of probe molecules comprises more than 100 probe molecules.

30. The method of claim 20, wherein the probe molecules are nucleic acid probes.

31. The method of claim 30, wherein each nucleic acid probe comprises
(i) a target-specific region that specifically binds to a target nucleic acid molecule; and
(ii) a region comprising a plurality of label-attachment regions linked together, wherein each label attachment region is attached to a plurality of label monomers that create a unique code for each target-specific probe, said code having a detectable signal that distinguishes one nucleic acid probe which binds to a first target nucleic acid from another nucleic acid probe that binds to a different second target nucleic acid molecule.

32. The method of claim 31, wherein the plurality of label-attachment regions comprises at least four label attachment regions.

33. The method of claim 31, wherein the plurality of label monomers comprises at least 4 label monomers.

34. The method of claim 31, wherein each of said label monomers are selected from the group consisting of a fluorochrome moiety, a fluorescent moiety, a dye moiety and a chemiluminescent moiety.

35. The method of claim 30, wherein the nucleic acid probe further comprises an affinity tag.

36. The method of claim 20, wherein the biological sample is a tissue or cell sample.

37. The method of claim 20, wherein the biological sample is a tumor sample.

38. The method of claim 37, wherein the tumor sample is a breast tissue sample.

39. The method of claim 20, wherein the biological sample is a formalin-fixed paraffin-embedded tissue sample.

40. The method of claim 20, wherein the signal is detected without target nucleic acid amplification.
